(19) United States
(12) Patent Application Publication
(10) Pub. No.: US 2018/0094149 A1
(43) Pub. Date: Apr. 5, 2018

(54) IMAGE FORMING METHOD AND IMAGE FORMING APPARATUS

(71) Applicant: Keita KATOH, Superior, CO (US)

(72) Inventor: Keita KATOH, Superior, CO (US)

(21) Appl. No.: 15/723,803

(22) Filed: Oct. 3, 2017

(30) Foreign Application Priority Data
Oct. 3, 2016 (JP) 2016-195833
Jul. 31, 2017 (JP) 2017-147949

(51) Int. Cl. C09D 11/033; C09D 11/40; C09D 11/322; C09D 11/324; C09D 133/02; B41J 11/00

(52) U.S. Cl. CPC C09D 11/033; C09D 11/40; B41J 11/002; C09D 11/324; C09D 133/02; C09D 11/322

(57) ABSTRACT

An image forming method includes applying an ink A containing carbon black, a first organic solvent, and water and an ink B containing a pigment including no carbon black, a second organic solvent, and water to a recording medium to form an image thereon and applying infrared rays to the image to dry the image. The average vapor pressure ratio {P(B)/P(A)} of the average vapor pressure P(B) of water and the second organic solvent contained in the ink B at 100 degrees C. to the average vapor pressure P(A) of water and the first organic solvent contained in the ink A at 100 degrees C. is from 1.00 to 2.00. The content ratio {W(A)/W(B)} of the content W(A) of the carbon black applied to the recording medium per unit area to the content W(B) of the pigment applied to the recording medium per unit area is from 1.00 to 100.0.

### CROSS-REFERENCE TO RELATED APPLICATIONS

This patent application is based on and claims priority pursuant to 35 U.S.C. § 119 to Japanese Patent Application Nos. 2016-195833 and 2017-147949, filed on Oct. 3, 2016, Jul. 31, 2017, respectively, in the Japan Patent Office, the entire disclosures of which are hereby incorporated by reference herein.

### BACKGROUND

### Technical Field

The present invention relates to an image forming method and an image forming apparatus.

### Description of the Related Art

In such an inkjet recording method, mostly dye ink using a water soluble dye as a coloring material is used. However, water resistance and light resistance of the water-soluble dye are inferior. This accelerates development of pigment ink using a water insoluble pigment in place of the water soluble dye.

In addition, in the fields of commercial printing and industrial printing, images are formed and dried at such a high speed as several tens meter per minute. Therefore, devices have been researched in many ways to efficiently and quickly dry printed matter.

To dry printed matter, for example, a convection method in which heated wind is applied to printed matter and a heat transfer method in which a heat source of high temperatures such as a heat roller is brought into contact with printed matter are typically used. However, these methods of drying printed matter are not suitable to sufficiently dry the printed matter. In a case of high speed printing, for example, several hundred meters per minute, images are transferred to overlapped paper and ink adheres to a conveying roller.

In an attempt to solve this issue, an inkjet method has been proposed in which printing is conducted using an inkjet ink containing a solvent in an amount of from 50 to 90 percent, the solvent including water in an amount of from 10 to 45 percent and having a surface tension of from 25 to 40 mN/m at 25 degrees C., a viscosity of from 1 to 50 mPa·s at degrees C., and a vapor pressure of 133 Pa or less at 25 degrees C., followed by irradiation of infrared rays.

### SUMMARY

According to the present invention, provided is an improved image forming method which includes applying an ink A containing carbon black, a first organic solvent, and water and an ink B containing a pigment including no carbon black, a second organic solvent, and water to a recording medium to form an image thereon and applying infrared rays to the image to dry the image. The average vapor pressure ratio {P(B)/P(A)} of the average vapor pressure P(B) of water and the second organic solvent contained in the ink B at 100 degrees C. to the average vapor pressure P(A) of water and the first organic solvent contained in the ink A at 100 degrees C. is from 1.00 to 2.00. The content ratio {W(A)/W(B)} of the content W(A) of the carbon black applied to the recording medium per unit area to the content W(B) of the pigment applied to the recording medium per unit area is from 1.00 to 100.0.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic diagram illustrating an example of the image forming apparatus of the present disclosure; and

FIG. 2 is a schematic diagram illustrating an evaluation diagram having a recording resolution of 1,200 dpi×1,200 dpi.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc. in the present disclosure represent the same meaning, unless otherwise specified.

Image Forming Method and Image Forming Apparatus

The image forming method of the present disclosure includes applying an ink A including carbon black, an organic solvent (first organic solvent), and water and an ink B including a pigment including no carbon black, an organic solvent (second organic solvent), and water to a recording medium to form an image thereon, and applying infrared rays to the image to dry the image. The average vapor pressure ratio {P(B)/P(A)} of the average vapor pressure P(B) of water and the organic solvent (second organic solvent) in the ink B at 100 degrees C. to the average vapor pressure P(A) of water and the organic solvent (first organic solvent) in the ink A at 100 degrees C. is from 1.00 to 2.00. Also, the content ratio {W(A)/W(B)} of the content W(A) of carbon black to the content W(B) of the pigment, both of carbon black and the pigment being applied to the recording medium per unit area, is from 1.00 to 100.0.

The image forming method of the present disclosure is made based on the knowledge that typically, the inkjet image recording method has a problem that color ink is not sufficiently dried if an image formed by using black ink containing carbon black and an image formed by using color ink containing pigments other than carbon black (i.e., including no carbon black) are mixed in an printed image.

The image forming apparatus of the present disclosure includes an image forming device configured to apply an ink A containing carbon black, an organic solvent (first organic solvent), and water and an ink B containing a pigment other than carbon black (i.e., including no carbon black), an organic solvent (second organic solvent), and water to a recording medium to form an image thereon; and a drying device to apply infrared rays to the image to dry the image. The average vapor pressure ratio {P(B)/P(A)} of the average vapor pressure P(B) of water and the second organic solvent contained in the ink B at 100 degrees C. to the average vapor pressure P(A) of water and the first organic solvent contained in the ink A at 100 degrees C. is from 1.00 to 2.00. Also, the content ratio {W(A)/W(B)} of the content W(A) of carbon black applied to the recording medium per unit area to a content W(B) of the pigment applied to the recording medium per unit area is from 1.00 to 100.0. The image forming method can be conducted by the image forming apparatus.

According to the present disclosure, an image forming method is provided which produces images with good drying property and free of image deficiency such as visible blister or kogation on plain paper and also commercial printing paper.

The kogation in the present disclosure means a portion having a difference of the values L* of an image between before and after the image is dried. The value L* is obtained in the following manner: an image is printed on a recording medium with 1,200 dpi×1,200 dpi. Within 5 seconds of the completion of printing, infrared rays are applied to the image at 4 cm above the image for 1.0 to 30.0 seconds by an infrared heater of from 200 to 1,300 degrees C. to dry the image. The image is measured by a reflection spectrodensitometer (X-Rite938, manufactured by S-Rite) to obtain the value of L*. In addition, if an image portion is deformed or broken due to burning upon an application of infrared rays, yellowed portion is included in the kogation.

Average Vapor Pressure Ratio P(B)/P(A)

The average vapor pressure ratio {P(B)/P(A)} of the average vapor pressure P(B) of water and the organic solvent in the ink B at 100 degrees C. to the average vapor pressure P(A) of water and the organic solvent in the ink A at 100 degrees C. is from 1.00 to 2.00. When the average vapor pressure ratio {P(B)/P(A)} is 1.00 or greater, in a print image in which an image formed using black ink containing carbon black and an image formed using color ink containing pigments other than carbon black are mixed, drying property of both inks ameliorates and quality images without visible kogation and blisters are obtained. When the average vapor pressure ratio {P(B)/P(A)} is 2.00 or less, in a print image in which an image formed using black ink containing carbon black and an image formed using color ink containing pigments other than carbon black are mixed, drying property of both inks ameliorates and quality images without visible kogation and blisters are obtained.

The average vapor pressure P(A) of water and the organic solvent in the ink A at 100 degrees C. to the average vapor pressure P(B) of water and the organic solvent in the ink B at 100 degrees C. can be obtained according to the following relation 1.

Average vapor pressure=content (percent by mass) of water in ink×vapor pressure of water at 100 degrees C. (101.325 mmHg)+content (percent by mass) of organic solvent 1 in ink×vapor pressure (mmHg) of organic solvent 1 at 100 degrees C.+content (percent by mass) of organic solvent 2 in ink×vapor pressure (mmHg) of organic solvent 2 at 100 degrees C.+•••+•••content (percent by mass) of organic solvent n in ink×vapor pressure (mmHg) of organic solvent n at 100 degrees C. Relation 1

Only the organic solvent accounting for 1.00 percent by mass of the total content of the ink is subject to the calculation of the average vapor pressure.

The average vapor pressure P(A) and the average vapor pressure P(B) have no particular limit and can be suitably selected to suit to a particular application. For example, it is preferably from 300 to 600 mmHg. When the average vapor pressure P(A) and the average vapor pressure P(B) are 300 mmHg or greater, drying property of ink ameliorates. When they are 600 mmHg or less, image quality can be enhanced because image deficiency such as kogation and blisters does not easily occur to a printed image.

The vapor pressure can be measured by using, for example, automatic vapor pressure measuring device (HERZOG HVP 972, manufactured by PAC).

The identification and the content of the organic solvent in ink can be measured according to, for example, Gas Chromatography-Mass spectrometry (GC-MS).

The content ratio {W(A)/W(B)} of the content W(A) of carbon black and the content W(B) of pigment other than carbon black which are applied to a recording medium per unit of area is from 1.00 to 100.0. When the content ratio {W(A)/W(B)} is 1.00 or higher, drying property of ink ameliorates. When it is 100.0 or less, image quality can be enhanced because image deficiency such as kogation and blisters does not easily occur to a printed image. In the printed image, the content ratio {W(A)/W(B)} is satisfied at least one area. Preferably, the portion satisfying the content ratio {W(A)/W(B)} accounts for 50 percent or greater of the entire image area, more preferably, 70 percent or greater, and particularly preferably 100 percent or greater.

The content ratio {W(A)/W(B)} can be controlled by the following manner.

It is possible to arbitrarily control the discharging amount (the number of discharging droplets and the amount of a single droplet) of black ink and color ink other than black ink from a discharging head in a particular limit. For the resolution of 1,200 dpi×1,200 dpi, the amount of a droplet and the number of droplets can be respectively controlled within the range of from 2.5 to 15 pL and 0 to 223,200 droplets.

Therefore, in the area of 1 cm², when the pigment concentration of ink is 6.00 percent by mass, the content W(A) of carbon black and the content W(B) of pigments other than carbon black applied to a recording medium per unit of area can be controlled within the range of from 0 to 200 μg/cm². In addition, if the number of heads along the conveying direction of paper is increased, the content of carbon black and the content of pigments other than carbon black can be increased. As described above, the content of carbon black and the content of pigments other than carbon black can be controlled so that the content ratio {W(A)/W(B)} can be controlled within the range specified above.

The content W(A) of carbon black and the content W(B) of pigments other than carbon black can be calculated based on the ink formulation, the amount of ink discharged from a discharging head, and the detailed condition of the image forming process.

The content W(A) of carbon black and the content W(B) of pigments other than carbon black can be calculated by the following method in addition to the calculation based on the ink formulation, the amount of ink discharged from a discharging head, and the detailed condition of the image forming process.

(1) The recording medium of 1 cm² onto which carbon black and pigments other than carbon black are applied is mixed with the following material and stirred by a juicer mixer (MetalLine_TM8100, manufactured by TESCOM & Co., Ltd.) for one minute to obtain liquid.

Material

Highly pure water at 30 degrees C.: 100 g

Aqueous solution of 3.75 percent by mass sodium hydroxide: 0.2 mL

Aqueous solution of 1.5 percent by mass DI-7020 (manufactured by Kao Corporation): 0.2 mL

(2) The liquid after being stirred is charged in a glass beaker (300 ml) and air is continuously blown into the liquid by an air pump non-noise S-100 (manufactured by (JAPAN PET DESIGN CO., LTD.) in an amount of 1.0 L/minute for 12 hours.
(3) The liquid into which the air has been blown is filtrated by a sieve having a 106 μm opening to take a filtrate
(4) 50 mL of hydrochloric acid of 1.0 mol/L is charged into the thus-obtained filtrate to dissolve calcium carbonate contained in the filtrate.
(5) The liquid obtained in (4) is subject to centrifugal separation under the following condition to take a precipitate (resin and pigment derived from ink).

Centrifugal: CS150GX (manufactured by Hitachi Koki Co., Ltd.)

Angle rotor: S150AT

Tube: PA seal tube (material: polypropylene copolymer)

Number of rotation during centrifugal separation: 150,000 rpm

Time for centrifugal separation: 15 minutes

(6) The thus-obtained precipitate is charged into 20 mL of methylene chloride to dissolve resins derived from ink.
(7) The mixture of precipitate and methylene chloride is again subject to centrifugal separation under the following condition to obtain precipitate (pigment).

Small centrifugal: Allegra X-30R (manufactured by Beckman Coulter, Inc.)

Swing rotor: SX4400

Tube: 25 mL glass tube

Number of rotation of centrifugal separation: 4,000 rpm

Time for centrifugal separation: 15 minutes

(8) All of the thus-obtained precipitate is placed in a glass petri dish having a diameter of 12 cm and dried in a constant temperature tank (DNF301, manufactured by Yamato Scientific Co., Ltd.) at 120 degrees C. for 12 hours.
(9) All of the thus-obtained precipitate is placed in a thermal analyzer (standard differential thermal scale TG-DTA/S, manufactured by Rigaku Corporation) and heated at 200 degrees C. for 30 minutes in an argon gas atmosphere using a platinum pan. Thereafter, the temperature is raised to 700 degrees C. at a temperature rising speed of 10 degrees C. per minute and held at 700 degrees C. for two hours. The mass lost from the time when the temperature is raised from 200 degrees C. until the temperature is held at 700 degrees C. for two hours is defined as X (mg) and the remnant after the temperature is held at 700 degrees C. for two hours is defined as Y (mg). At this point, X is the mass of the pigment other than carbon black applied to the recording medium of 1 cm² and Y is the mass of carbon black applied to the recording medium of 1 cm².

The content W(A) (μg/cm²) of carbon black applied to the recording medium per unit of area is preferably from 1.2 to 1,400 μg/cm², more preferably from 1.2 to 1,200 μg/cm², and particularly preferably from 7.5 to 14.85 μg/cm².

The content W(B) (μg/cm²) of carbon black applied to the recording medium per unit of area is preferably from 0.15 to 400 μg/cm² and more preferably from 0.15 to 7.5 μg/cm².

The unit of area means an area of a square of 1 cm², and can be set to any site on an image. Preferably, it is set to all the image area. Also, it is possible to set it on a solid image portion or a black solid image portion.

Mass Ratio X(A) and Mass Ratio X(B)

The mass ratio X(A) {carbon black/(organic solvent+water)} of the content of carbon black contained in the ink A to the total content of water and the organic solvent contained in the ink A and the mass ratio X(B) {pigment other than carbon black/(organic solvent+water)} of the content of the pigment other than carbon black contained in the ink B to the total content of water and the organic solvent contained in the ink B are preferably from 0.55 to 25.5 percent by mass. When the mass ratio X(A) and the mass ratio X(B) are 0.55 percent by mass or greater, it is possible to obtain an image sufficiently dried on both plain paper and commercial printing paper. When they are 25.50 percent by mass or less, good images with less image deficiency such as kogation and blister can be obtained. Only the organic solvent accounting for 1.00 percent by mass or more of the total content of the ink is subject to the calculation of the mass ratio X(A) and the mass ratio X(B) of the present disclosure.

Ratio X(A)/X(B)

The ratio {X(A)/X(B)} of the mass ratio X(A) (percent by mass) of carbon black to the mass ratio X(B) (percent by mass) of the pigments other than carbon black is preferably from 1.0 to 10.0 and more preferably from 1.20 to 10.0. When the ratio {X(A)/X(B)} is 1.0 or greater, drying property of ink ameliorates. When it is 10.0 or less, image quality can be enhanced because image deficiency such as kogation and blisters does not easily occur to a printed image.

The content of carbon black and the content of the pigments other than carbon black contained in ink if the formulation of the ink is clear.

If the ink formulation is unclear, the content of carbon black and the content of the pigment can be obtained in the following manner.

(1) The ink of 2.00 mL is subject to centrifugal separation under the following condition to take a precipitate (resin and pigment derived from ink).

### Condition

Centrifugal: CS150GX (manufactured by Hitachi Koki Co., Ltd.)

Angle rotor: S150AT

Tube: PA seal tube (material: propylene copolymer)

Number of rotation during centrifugal separation: 150,000 rpm

Time for centrifugal separation: 15 minutes

(2) The thus-obtained precipitate is charged into 20 mL of methylene chloride to dissolve resins derived from ink.
(3) The mixture of precipitate and methylene chloride is again subject to centrifugal separation under the following condition to obtain precipitate (pigment).

Condition

Small centrifugal: Allegra X-30R (manufactured by Beckman Coulter, Inc.)

Swing rotor: SX4400

Tube: 25 mL glass tube

Number of rotation of centrifugal separation: 4,000 rpm

Time for centrifugal separation: 15 minutes

(4) All of the thus-obtained precipitate is placed in a glass petri dish having a diameter of 12 cm and dried in a constant temperature tank (DNF301, manufactured by Yamato Scientific Co., Ltd.) at 120 degrees C. for 12 hours.
(5) All of the thus-obtained precipitate is placed in a standard type differential thermal scale (TG-DTA/S, manufactured by Rigaku Corporation) and heated at 200 degrees C. for 30 minutes in an argon gas atmosphere using a platinum pan. Thereafter, the temperature is raised to 700 degrees C. at a temperature rising speed of 10 degrees C. per minute and held at 700 degrees C. for two hours. The mass lost from the time when the temperature is raised from 200 degrees C. until the temperature is held at 700 degrees C. for two hours is defined to correspond to the pigment other than carbon black contained in 2.00 ml of ink and the remnant after the temperature is held at 700 degrees C. for two hours is defined to correspond to carbon black contained in 2.00 mL of ink.

The total content of the carbon black and the pigment other than the carbon black in an area of 210 mm×297 mm (A4) of the recording medium on which the image is formed is preferably from 1.0 to 1,000.0 mg. When the total content is 1.0 mg or greater, drying property of an image can be improved. When the total content is 1,000.0 mg or less, kogation and blister visible on an image portion can be reduced. Namely, anti-kogation property and anti-blister property can be improved.

In the present disclosure, anti-kogation property means how difficult to cause visible kogation to occur.

Also, in the present disclosure, anti-blister property means how difficult to cause visible blister to occur.

Image Free of Image Deficiency Such As Visible Blister and Kogation

The total content of carbon black and the pigments other than carbon black attached to the recording medium can be adjusted by changing the number of dots of print chart and the amount of ink discharged from heads.

The total content of carbon black and the pigments other than carbon black can be calculated based on the ink formulation, the amount of ink discharged from a discharging head, and the detailed condition of the image forming process.

The total content of carbon black and pigments other than carbon black can be calculated by the following method in addition to the calculation based on the ink composition, the amount of ink discharged from discharging heads, and the detailed condition of the image forming process.

(1) The recording medium of a size of A4 onto which carbon black and the pigments other than carbon black are applied is mixed with the following material and stirred by a juicer mixer (MetalLine_TM8100, manufactured by TESCOM & Co., Ltd.) for 30 minutes.

Material

Highly pure water at 30 degrees C.: 500 g

Aqueous solution of 3.75 percent by mass sodium hydroxide: 2.0 mL

Aqueous solution of 1.5 percent by mass DI-7020 (manufactured by Kao Corporation): 2.0 mL

(2) The liquid after being stirred is charged in a glass beaker (2,000 ml) and air is continuously blown into the liquid by an air pump non-noise S-100 (manufactured by (JAPAN PET DESIGN CO., LTD.) in an amount of 1.0 L/minute for 12 hours.
(3) The liquid into which the air has been blown is filtrated by a sieve having a 106 μm opening to take a filtrate
(4) 500 mL of hydrochloric acid of 1.0 mol/L is charged into the thus-obtained filtrate to dissolve calcium carbonate contained in the filtrate.
(5) The liquid obtained in (4) is subject to centrifugal separation under the following condition to take a precipitate (resin and pigment derived from ink).

Condition

Centrifugal: CP100NX (manufactured by Hitachi Koki Co., Ltd.)

Swing rotor: P21 A2

Tube: 230PA bottle (material: polypropylene copolymer)

Number of rotation during centrifugal separation: 20,000 rpm

Time for centrifugal separation: 30 minutes

(6) The thus-obtained precipitate is charged into 100 mL of methylene chloride to dissolve resins derived from ink.
(7) The mixture of precipitate and methylene chloride is again subject to centrifugal separation under the following condition to obtain precipitate (pigment).

### Condition

Small centrifugal: Allegra X-30R (manufactured by Beckman Coulter, Inc.)

Swing rotor: SX4400

Tube: 25 mL glass tube×4

Number of rotation of centrifugal separation: 4,000 rpm

Time for centrifugal separation: 15 minutes

(8) All of the thus-obtained precipitate is placed in a glass petri dish having a diameter of 12 cm and dried in a constant temperature tank (DNF301, manufactured by Yamato Scientific Co., Ltd.) at 120 degrees C. for 12 hours.
(9) All of the thus-obtained precipitate is placed in a thermal analyzer (standard differential thermal scale TG-DTA/S, manufactured by Rigaku Corporation) and heated at 200 degrees C. for 30 minutes in an argon gas atmosphere using a platinum pan. Thereafter, the temperature is raised to 700 degrees C. at a temperature rising speed of 10 degrees C. per minute and held at 700 degrees C. for two hours. The mass lost from the time when the temperature is raised from 200 degrees C. until the temperature is held at 700 degrees C. for two hours is defined as α (mg) and the remnant after the temperature is held at 700 degrees C. for two hours is defined as β (mg). At this point, α is the mass of the pigment other than carbon black applied to the recording medium of A4 and β is the mass of carbon black applied to the recording medium of A4.

Image Forming Process and Image Forming Device

The image forming process includes applying an ink A containing carbon black, an organic solvent, and water and an ink B containing pigments other than the carbon black, an organic solvent, and water to a recording medium to form an image.

The image forming device applies an ink A containing carbon black, an organic solvent, and water and an ink B containing pigments other than the carbon black, an organic solvent, and water to a recording medium to form an image.

The image forming method can be conducted by the image forming device.

A method of applying the ink A and the ink B to a recording medium to form an image include, for example, applying a stimulus to each ink to jet the ink to the recording medium.

The stimulus mentioned above has no specific limit and can be suitably selected to a particular application. For example, heat (temperature), pressure, vibration, and light can be suitably used as the stimulus. These can be used alone or in combination. Of these, heat and pressure are preferable.

How to jet the ink includes, for example, a so-called piezoelectric method in which, using a piezoelectric element as a pressure generating device to apply a pressure to the ink in an ink flowing paths, a diaphragm forming the wall of the ink flowing path is transformed to change the volume of the ink flowing path, thereby discharging ink droplets; a thermal method in which ink is heated in an ink flowing path to produce bubbles using a heat element; and an electrostatic method in which an electrostatic force generated between a diaphragm forming the wall of the ink flowing path and an electrode disposed facing each other transforms the diaphragm to change the volume of the ink flowing path, thereby discharging ink droplets.

For example, the ink droplet to be jetted preferably has a size of from 3 to 40 pL, a discharging speed of from 5 to 20 m/s, a drive frequency of 1 kHz or greater, and a resolution of 300 dpi or greater.

The ink can be accommodated in a container such as an ink cartridge for use.

Ink A

The ink A contains carbon black, an organic solvent, and water. It may furthermore optionally contain other components.

Carbon Black

Carbon black in the present disclosure is defined as a colorant for use in the ink.

As carbon black, carbon black manufactured by, for example, a furnace method or a channel method, is preferable. Also, the carbon black preferably has an average primary particle diameter of from 15 to 40 μm, a specific surface area of BET method of from 50 to 300 square meter/g, a DBP oil absorption amount of from 40 to 150 mL/100 g, a volatile amount of from 0.5 to 10 percent, and a pH of from 2 to 9.

The carbon black mentioned above has no particular limit and can be suitably selected to suit to a particular application.

Specific examples include, but are not limited to, No. 2300, No. 900, MCF-88, No. 33, No. 40, No. 45, No. 52, MA7, MA8, MA100, and No. 2200B (all manufactured by Mitsubishi Chemical Corporation); Raven 700, Raven 5750, Raven 5250, Raven 5000, Raven 3500, and Raven 1255 (all manufactured by Colombia Co., Ltd.), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all manufactured by Cabot Corporation); and Color Black FW1, Color Black FW2, Color Black FW2V, Color Black FW18, Color Black 200, Color Black S150, Color Black S160, Color Black S170, Printex 35, Printex U, Printex V, Printex 140U, Printex 140V, and Special Black 6, Special Black 5, Special Black 4A, and Special Black 4 (all manufactured by Evonik Industries AG).

The content of the carbon black is preferably from 1.0 to 1,000.0 mg for an area of 210 mm×297 mm (A4 size) of a recording medium.

Organic Solvent

There is no specific limitation on the type of the organic solvent used in the present disclosure. For example, water-soluble organic solvents are suitable. Examples are polyols, ethers such as polyol alkylethers and polyol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrolidone, N-methyl-2-pyrolidone, N-hydroxyethyl-2-pyrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioneamide, and 3-buthoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate.

To serve as a humectant and impart a good drying property, it is preferable to use an organic solvent having a boiling point of 250 degrees C. or lower.

An example of the organic solvent is 3-ethyl-3-hydroxymethyl oxetane.

Polyol compounds having eight or more carbon atoms and glycol ether compounds are also suitable. Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyol alkylethers such as ethyleneglycol monoethylether, ethyleneglycol monobutylether, diethyleneglycol monomethylether, diethyleneglycol monoethylether, diethyleneglycol monobutylether, tetraethyleneglycol monomethylether, and propyleneglycol monoethylether; and polyol arylethers such as ethyleneglycol monophenylether and ethyleneglycol monobenzylether.

The polyol compounds having eight or more carbon atoms and glycolether compounds enhance permeability of ink when paper is used as a print medium (recording medium).

The proportion of the organic solvent in ink has no particular limit and can be suitably selected to suit to a particular application.

In terms of the drying property and discharging reliability of the ink, the proportion is preferably from 10 to 60 percent by mass and more preferably 20 to 60 percent by mass.

Water

There is no specific limitation to water and it can be suitably selected to suit to a particular application. Examples are deionized water, ultrafiltered water, reverse osmosis water, pure water such as distilled water, and ultra pure water. These can be used alone or in combination.

The proportion of the water is preferably from 20 to 80 percent by mass to the total content of the ink A.

Other Components

There is no specific limitation to the selection of the other components. For example, foam inhibitors (defoaming agent), pH regulators, preservatives and fungicides, chelate reagents, corrosion inhibitors, anti-oxidants, ultraviolet absorbers, oxygen absorbers, and photostabilizing agents can be selected.

Surfactant

Examples of the surfactant are silicone-based surfactants, fluorochemical surfactants, amphoteric surfactants, nonionic surfactants, anionic surfactants, etc.

The silicone-based surfactant has no specific limit and can be suitably selected to suit to a particular application. Of these, preferred are silicone-based surfactants which are not decomposed even in a high pH environment.

Specific examples include, but are not limited to, side-chain-modified polydimethylsiloxane, both-distal-end-modified polydimethylsiloxane, one-distal-end-modified polydimethylsiloxane, and side-chain-both-distal-end-modified polydimethylsiloxane. A silicone-based surfactant having a polyoxyethylene group or a polyoxypropylene group as a modification group is particularly preferable because such an agent demonstrates good properties as an aqueous surfactant. It is possible to use a polyether-modified silicone-based surfactant as the silicone-based surfactant. A specific example is a compound in which a polyalkylene oxide structure is introduced into the side chain of the Si site of dimethyl silooxane.

Specific examples of the fluorochemical surfactants include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because they do not easily produce foams. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, salts of sulfuric acid ester of polyoxyalkylene ether polymer having a perfluoroalkyl ether group in its side chain and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactants has no particular limit and can be suitably selected to suit to a particular application.

Specific examples thereof include, but are not limited to, side-chain-modified polydimethyl siloxane, both distal-end-modified polydimethylsiloxane, one-distal-end-modified polydimethylsiloxane, and side-chain-both-distal-end-modified polydimethylsiloxane. In particular, a polyether-modified silicone-based surfactant having a polyoxyethylene group or a polyoxyethylene polyoxypropylene group is particularly preferable because such a surfactant demonstrates good characteristics as an aqueous surfactant.

Any suitably synthesized surfactant and any product thereof available on the market is suitable. Products available on the market can be obtained from Byc Chemie Japan Co., Ltd., Shin-Etsu Silicone Co., Ltd., Dow Corning Toray Co., Ltd., etc., NIHON EMULSION Co., Ltd., Kyoeisha Chemical Co., Ltd., etc.

The polyether-modified silicon-based surfactant has no particular limit and can be suitably selected to suit to a particular application. For example, a compound is usable in which the polyalkylene oxide structure represented by the following Chemical formula S-1 is introduced into the side chain of the Si site of dimethyl polysiloxane.

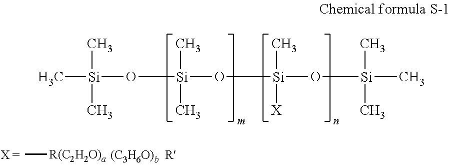

In the Chemical formula S-1, “m”, “n”, “a”, and “b” each, respectively independently represent integers, R represents an alkylene group, and R′ represents an alkyl group.

Specific examples of polyether-modified silicone-based surfactants include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Japan KK.), and TSF4440, TSF4452, and TSF4453 (all manufactured by Momentive Performance Materials Inc.).

A fluorochemical surfactant in which the number of carbon atoms replaced with fluorine atoms is 2-16 is preferable and, 4 to 16, more preferable.

Specific examples of the fluorochemical surfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain. Of these, polyoxyalkylene ether polymer compounds having a perfluoroalkyl ether group in its side chain are preferable because they do not foam easily and the fluorosurfactant represented by the following Chemical formula F-1 or Chemical formula F-2 is more preferable.

CF₃CF₂(CF₂CF₂)ₘ—CH₂CH₂O(CH₂CH₂O)ₙH Chemical formula F-1

In the Chemical formula F-1, “m” is preferably 0 or an integer of from 1 to 10 and “n” is preferably 0 or an integer of from 1 to 40.

CₙF₋₂ₙ₊₁—CH₂CH(OH)CH₂—O—(CH₂CH₂O)ₐ—Y Chemical formula F-2

In the compound represented by the chemical formula F-2, Y represents H or CₘF_{2m|1}, where n represents an integer of from 1 to 6, or CH₂CH(OH)CH₂—CₘF_{2m|}1, where m represents an integer of from 4 to 6, or CₚH₂ₚ₊₁, where p is an integer of from 1 to 19. “n” represents an integer of from 1 to 6. “a” represents an integer of from 4 to 14.

As the fluorochemical surfactant, products available on the market may be used.

Specific examples include, but are not limited to, SURFLON S-111, SURFLON S-112, SURFLON S-121, SURFLON S-131, SURFLON S-132, SURFLON S-141, and SURFLON S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL TBS, FSP, FSA, FSN-100, FSN, FSO-100, FSO, FS-300, UR, and Capstone™ FS-30, FS-31, FS-3100, FS-34, and FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.); and UNIDYNE™ DSN-403N (manufactured by DAIKIN INDUSTRIES, Ltd.). Of these, in terms of improvement on print quality, in particular coloring property and permeability, wettability, and uniform dying property on paper, FS-3100, FS-34, and FS-300 of The Chemours Company, FT-110, FT-250, FT-251, FT-400S, FT-150, and FT-400SW of NEOS COMPANY LIMITED, POLYFOX PF-151N of OMNOVA SOLUTIONS INC., and UNIDYNE™ DSN-403N (manufactured by DAIKIN INDUSTRIES, Ltd.) are particularly preferable.

The proportion of the surfactant to the entire ink A is preferably from 0.001 to 5 percent by mass and more preferably from 0.5 to 3 percent by mass. When the content is from 0.001 to 5 percent by mass, permeation and wettability to plain paper and commercial printing paper can be improved and also fixability can be enhanced.

Water-Dispersible Resin

As the water-dispersible resin, resins having excellent film-forming (image forming) property, water repellency, water-resistance, and weather resistance are suitable for image recording of high water-resistance and high image density (high coloring property). For example, condensation-based synthetic resins, addition-based synthetic resins, and natural polymers are suitable. These can be used alone or in combination.

Specific examples of the condensation-based synthetic resins include, but are not limited to, polyester resins, polyurethane resins, polyepoxy resins, polyamide resins, polyether resins, poly(meth)acrylic resins, acrylic-silicone resins, and fluorochemical resins.

Specific examples of the addition-based synthetic resins include, but are not limited to, polyolefin resins, polystyrene-based resins, polyvinyl alcohol-based resins, polyvinyl ester-based resins, polyacrylic acid-based resins, and unsaturated carboxylic acid-based resins.

Specific examples of the natural polymer include, but are not limited to, celluloses, rosins, and natural rubber.

Of these, acrylic silicone-based resins and fluorochemical resins are preferable.

As the water-dispersible resin, self-dispersible resins having a hydrophilic group or resins themselves having no dispersibility while dispersibility is imparted by a surfactant or a resin having a hydrophilic group are suitable. Of these, emulsions of resin particles obtained by emulsion polymerization or suspension polymerization of ionomers or unsaturated monomers of a polyester resin or polyurethane resin are preferable.

In the case of emulsion polymerization of an unsaturated monomer, since an unsaturated monomer, a polymerization initiator, a surfactant, a chain transfer agent, a chelate agent, a pH regulator, etc. are added in water to conduct reaction to obtain a resin emulsion, it is easy to obtain a water-dispersible resin and change the resin components. Therefore, a water-dispersible resin having target properties is easily obtained.

Since dispersion breakage or cleavage of molecular chains ascribable to hydrolysis, etc. is caused in a strong alkali or strong acid environment, pH is preferably from 4 to 12. It is more preferably from 6 to 11 and particularly preferably from 7 to 10 in terms of the miscibility with a water-dispersible colorant.

The volume accumulation average particle diameter (D₅₀) of the water-dispersible resin is related to viscosity of a liquid dispersion. If the formulation is the same, viscosity of the same solid portion increases as the particle diameter decreases. To prevent excessively high viscosity when ink is prepared, the volume accumulation average particle diameter (D₅₀) is preferably 50 nm or greater. In addition, particles having a particle diameter as large as several tens μm are larger than the size of the nozzle opening of an inkjet head, which is not usable. When particles are smaller than the nozzle opening but large particles are still present in ink, the discharging performance of the ink tends to deteriorate. The volume accumulation average particle diameter (D₅₀) of the water-dispersible resin in the ink is preferably 200 nm or less and more preferably 150 nm or less in order not to degrade the ink discharging property. The volume accumulation average particle diameter (D₅₀) can be measured by particle size distribution measuring instrument (NANOTRAC UPA-EX-150, manufactured by NIKKISO CO., LTD.).

In addition, the water-dispersible resin fixes the water-dispersible colorant on paper and forms a film at room temperature to improve the fixability of the colorant. Therefore, the minimum film-forming temperature (MFT) of the water-dispersible resin is preferably 30 degrees C. or lower.

In addition, when the glass transition temperature of the water-dispersible resin is −40 degrees C. or lower, viscosity of the resin film increases, thereby causing tackiness on printed matter. Therefore, the glass transition temperature of the water-dispersible resin is preferably higher than −40 degrees C. and more preferably −30 degrees C. or higher to prevent occurrence of tackiness.

The proportion of the water-dispersible resin in the ink A is preferably from 0.5 to 10 percent by mass and more preferably from 1 to 8 percent by mass.

Defoaming Agent

The defoaming agent has no particular limit. For example, silicon-based defoaming agents, polyether-based defoaming agents, and aliphatic acid ester-based defoaming agents are suitable. These can be used alone or in combination. Of these, silicone-based defoaming agents are preferable in terms of the effect of breaking foams.

Preservatives and Fungicides

The preservatives and fungicides are not particularly limited. A specific example is 1,2-benzisothiazoline-3-one.

Corrosion Inhibitor

The corrosion inhibitor has no particular limitation. Examples are acid sulfites and sodium thiosulfates.

pH Regulator

The pH regulator can be any agent capable of adjusting the pH in the range of form 7 to 11 without having an adverse impact on formulated ink and suitably selected to suit to a particular application.

Specific examples of the pH regulator include, but are not limited to, alcohol amines, hydroxides of alkali metal elements, hydroxides of ammonium, phosphonium hydroxides, and alkali metal carbonates. When the pH is less than 7 and greater than 11, an inkjet head and an ink supplying unit tend to be greatly dissolved, which may lead to modification, leakage, poor discharging performance, etc. of the ink.

Specific examples of the alcohol amines include, but are not limited to, diethanol amine, triethanol amine, and 2-amino-2-ethyl-1,3-propane diol.

Specific examples of the hydroxides of alkali metal elements include, but are not limited to, lithium hydroxide, sodium hydroxide, and potassium hydroxide.

Specific examples of the ammonium hydroxides include, but are not limited to, ammonium hydroxide and quaternary ammonium hydroxide.

A specific example of the phosphonium hydroxides is quaternary phosphonium hydroxide.

Specific examples of the carbonates of alkali metal elements include, but are not limited to, lithium carbonate, sodium carbonate, and potassium carbonate.

Anti-Oxidant

Specific examples of the anti-oxidants include, but are not limited to, phenol-based anti-oxidants (including hindered phenol-based anti-oxidants), amino-based anti-oxidants, sulfur-based anti-oxidants, and phosphorous-based anti-oxidants.

Ultraviolet Absorber

Specific examples of the ultraviolet absorbers include, but are not limited to, benzophenone-based ultraviolet absorbents, benzotriazole-based ultraviolet absorbents, salicylate-based ultraviolet absorbents, cyanoacrylate-based ultraviolet absorbents, and nickel complex salt-based ultraviolet absorbents.

Ink B

The ink B contains pigments other than the carbon black mentioned above, an organic solvent, and water. It may furthermore optionally contain other components.

Two or more kinds of the ink B can be used to conduct the image forming method of the present disclosure using the image forming apparatus.

Pigment Other than Carbon Black

Cyan pigments, magenta pigments, yellow pigments, etc. can be used as the pigment other than the carbon black. These can be used alone or in combination.

The pigment other than the carbon black has no specific limit and is suitably selected to suit to a particular application. For example, inorganic pigments and organic pigments are usable. These can be used alone or in combination.

Specific examples of the inorganic pigments include, but are not limited to, titanium oxide, iron oxide, calcium oxide, barium sulfate, aluminum hydroxide, barium yellow, cadmium red, and chrome yellow.

Specific examples of the organic pigments include, but are not limited to, azo pigments, polycyclic pigments, dye chelate, nitro pigments, nitroso pigments, and aniline black. Of these, azo pigments and polycyclic pigments are preferable.

Specific examples of the azo pigments include, but are not limited to, azo lake, insoluble azo pigments, condensation azo pigments, and chelate azo pigments.

Specific examples of the polycyclic pigments include, but are not limited to, phthalocyanine pigments, perylene pigments, perinone pigments, anthraquinone pigments, quinacridone pigments, dioxazine pigments, indigo pigments, thioindigo pigments, isoindolinone pigments, and quinofuranone pigments.

Specific examples of the dye chelates include, but are not limited to, bass dye type chelates and acid dye type chelates.

Specific examples of the organic pigment include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 408, 109, 110, 117, 120, 128, 139, 150, 151, 153, 155, 180, 183, 185 and 213; C.I. Pigment Orange 5, 13, 16, 17, 36, 43, and 51; C.I. Pigment Red 1, 2, 3, 5, 17, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 185, 190, 193, 209, and 219; C.I. Pigment Violet 1 (Rohdamine Lake), 3, 5:1, 16, 19, 23, and 38; C.I. Pigment Blue 1, 2, 15 (Phthalocyanine Blue), 15:1, 15:2, 15:3 (Phthalocyanine Blue), 16, 17:1, 56, 60, and 63; and C.I. Pigment Green 1, 4, 7, 8, 10, 17, 18, and 36. These can be used alone or in combination.

The content of the pigments other than the carbon black is preferably from 1.0 to 1,000.0 mg for an area of 210 mm×297 mm (A4 size) of a recording medium.

Examples of the pigment (carbon black and pigments other than carbon black) are a surfactant dispersion pigment in which a pigment is dispersed by a surfactant, a resin dispersion pigment in which a pigment is dispersed by a resin, a resin coated dispersion pigment in which the surface of a pigment is covered with a resin, and a self-dispersible pigment in which a hydrophilic group is provided to the surface of a pigment. Of these, pigments having water dispersibility are preferable. The resin coated dispersion pigment and the self-dispersible pigment are preferable. More preferable is a pigment having at least one hydrophilic group on the surface of the pigment.

Specific examples of such hydrophilic groups include, but are not limited to, —COOM, —SO₃M, —PO₃HM, —PO₃M₂, —CONM₂, —SO₃NM₂, —NH—C₆H₄—COOM, —NH—C₆H₄—SO₃M, —NH—C₆H₄—PO₃HM, —NH—C₆H₄—P₀₃M₂, —NH—C₆H₄—CONM₂, and —NH—C₆H₄—SO3NM₂. These hydrophilic groups can be introduced by known methods. M represents a counter ion.

There is no specific limit to M as a counter ion and it can be suitably selected to suit to a particular application. For example, quaternary ammonium ions are preferable.

Specific examples of the quaternary ammonium ions include, but are not limited to, tetramethyl ammonium ion, tetraethyl ammonium ion, tetrapropyl ammonium ion, tetrabutyl ammonium ion, tetra pentyl ammonium ion, benzyl trimethyl ammonium ion, benzyl triethyl ammonium ion, and tetrahexyl ammonium ion. Of these, tetraethyl ammonium ion, tetrabutyl ammonium ion, and benzyl trimethyl ammonium ion are preferable and tetrabutyl ammonium ion is more preferable.

In particular, the ink using the pigment mentioned above has excellent storage stability over time. Also, the viscosity rise during moisture vaporing is suppressed. This is because even when moisture is evaporated from water rich ink so that the ink becomes organic solvent rich, dispersion of a pigment is inferred to be kept stable by the hydrophilic group having a quaternary ammonium ion.

A polymer emulsion including a polymer particle including a pigment is preferable as the colorant other than the pigment having a hydrophilic group. The pigment can be encapsulated in a polymer particle or adsorbed to the surface thereof. In this case, it is not necessary that all the pigments are encapsulated or adsorbed. The pigments may be partially dispersed in an emulsion.

As the polymer for polymer particle, vinyl-based polymers, polyester-based polymers, and polyurethane-based polymers are usable. Of these, vinyl-based polymers and polyester-based polymers are preferable.

As the organic solvent, the same organic solvent as those for the ink A can be used.

As the water, the same water as those for the ink A can be used.

As the other components, the same other components as those for use in the ink A can be used.

The BET specific surface area of carbon black and the pigments other than carbon black is preferably from 10 to 1,500 m²/g, more preferably from 20 to 600 m²/g, and particularly preferably from 50 to 300 m²/g. If a pigment does not have such a suitable specific surface area, the pigment is subject to typical size reduction treatment or pulverization treatment (for example, a ball mill pulverization, a jet mill pulverization, or ultrasonic wave treatment) to obtain a relatively small particle diameter. The BET specific surface area can be measured by an automatic specific surface area/fine hole distribution measuring device TriStar 3000 (manufactured by Shimadzu Corporation).

The volume accumulation average particle diameter (D₅₀) of carbon black and the pigments other than carbon black has no particular limit and can be suitably selected to suit to a particular application. For example, it is preferably from 10 to 200 nm in ink. The volume accumulation average particle diameter (D₅₀) can be measured by particle size distribution measuring instrument (NANOTRAC UPA-EX-150, manufactured by NIKKISO CO., LTD.).

Method of Manufacturing Ink

The ink A and the ink B are manufactured by dispersing or dissolving each pigment, organic solvents, water, and other optional components in an aqueous medium followed by stirring and mixing, if desired.

The stirring and mixing are conducted by, for example, a sand mill, a homogenizer, a ball mill, a paint shaker, an ultrasonic dispersing device, using a stirrer equipped with a normal stirring wing, a magnetic stirrer, and a high performance dispersing device.

Recording Medium

There is no specific limitation to the recording medium and it can be suitably selected to suit to a particular application. For example, plain paper, gloss paper, special paper, cloth, film, transparent sheets, general printing paper, etc. are suitable. The ink is excellent in terms that quality recording is possible on commercial printing paper as well as other kinds of paper.

The commercial printing paper has a coated layer on at least one side of the substrate of the printing paper. An example is printing paper using a filler such as calcium carbonate and kaolin as the material for the coated layer.

Coated printing paper as an example of the commercial printing paper has a coated layer formed of white pigment such as clay (kaolin) or calcium carbonate and an adhesive (binder) such as starch.

Recorded matter having an image formed with the ink has high quality free of image blur and excellent stability over time so that it can be suitably used for various purposes as reference material, on which texts, images, etc. are recorded.

Of these, a recording medium having a liquid imbibition in a particular range is suitable in terms of recording images having good image quality (image density, saturation, beading, color bleed) and high gloss with excellent smear fixability. Specifically, commercial printing paper having a coated layer on at least one side of the substrate is good. It is preferable that such paper have a transfer amount of pure water to the side of the coated layer of from 2 to 35 mL/m² in a contact time of 100 ms and from 3 to 40 ml/m² in a contact time of 400 ms as measured by a liquid dynamic absorption tester. If the transfer amount of pure water is excessively small in comparison with those ranges, beading (a phenomenon in which adjacent dots attracted to each other make images look rough) and color bleed (bleeding between colors) tend to occur even if the ink mentioned above is used. When a recording medium having an excessively large transfer amount of pure water is used, the ink dot diameter after recording tends to become smaller than desired, so that solid images may not be filled with the ink.

The transfer amount of pure water can be measured by a dynamic scanning absorptometer (K350 Series D type, manufactured by KYOWA SEIKO INC.). Each of the transfer amount in the contact time of 100 ms can be obtained by interpolation of the measuring results of the transfer amount in the proximity contact time of the respective contact periods of time.

Printing paper having a liquid imbibition in a particular range is available on the market.

Specific examples thereof include, but are not limited to, POD GLOSS COAT, OK TOP COAT+, OK KINFUJI+, and SA KINFUJI+(manufactured by Oji Paper Co., Ltd.), SUPER MI DUL, AURORA COAT, and SPACE DX (manufactured by Nippon Paper Industries Co., Ltd.), α matte and μ coat (manufactured by HOKUETSU KISHU PAPER CO., LTD.), and PEARL COAT N (manufactured by Mitsubishi Paper Mills Limited).

Drying Process and Drying Device

In the drying process, the image is dried due to infrared rays. It preferably includes drying treatment using heated wind.

In the drying process, the image is dried due to infrared rays. It preferably includes drying treatment using heated wind.

The drying process can be suitably conducted by the drying device.

The drying process can be conducted by irradiation of infrared rays.

The infrared rays have no particular limit and can be suitably selected to suit to a particular application. For example, it includes near infrared rays having a wavelength of from 0.7 to 2.0 μm, middle-range infrared rays of from 2.0 to 4.0 μm, and far infrared rays of from 4.0 to 1,000 μm.

The infrared rays can be obtained directly from a heat source or via a heat medium through which effective irradiation of infrared rays are generated. For example, it is suitable to use electric-discharge lamps or carbon dioxide laser of mercury, xenon, cesium, sodium. Also, infrared rays can be obtained by heating an electric resistance of, for example, platinum, tungsten, nichrome, and Kanthal.

Radiant heat source is preferable as the heat source.

There is no specific limitation to the drying process and the drying device and they can be suitably selected to suit to a particular application. The temperature (drying temperature) and the drying time of radiant heat source can be suitably selected.

The temperature (drying temperature) of the radiant heat source is preferably from 200 to 1,300 degrees C. When the drying temperature is 200 degrees C. or higher, drying property of printed images ameliorates. When it is 1,300 degrees C. or lower, image quality can be enhanced because image deficiency such as kogation and blisters does not easily occur to a printed image.

The drying time indicates time during which a printed image is irradiated with infrared rays. It is preferably from 1.0 to 30.0 seconds and more preferably from 6.0 to 30.0 seconds. When the drying time is 1.0 second or more, drying property of a printed image ameliorates. When it is 30.0 seconds or less, image quality can be enhanced because image deficiency such as kogation and blisters does not easily occur to the printed image.

Drying Treatment by Heated Wind and Drying Member

The drying process and the drying device can employ heated wind to dry a printed image in addition to the drying due to infrared rays.

There is no specific limitation to the heated wind generating device to conduct drying by heated wind and it can be suitably selected to suit to a particular application. For example, warm air driers, hot air generators etc., available on the market can be used.

The temperature of the heated wind is preferably 80 degrees C. or higher and more preferably 100 degrees C. or higher. When the temperature of the heated wind is 80 degrees C. or higher, the drying property of a printed image can be enhanced. In addition, by using heated wind, image deficiency such as kogation and blister of image portions is reduced so that image quality can be improved. The temperature of the heated wind can be measured by K type thermocouple (front end welding type, line diameter: 0.2 mm, manufactured by ThreeHigh Co., Ltd.). The K type thermocouple is brought into contact with a recording medium to measure the temperature of heated wind.

The drying time by heated wind is preferably from 5 to 30 seconds and more preferably from 10 to 20 seconds.

When the warm air drier is used, the wind speed of the heated wind is preferably from 10 to 30 m/s and more preferably from 15 to 25 m/s.

Examples of the image forming apparatus for use in the image forming method of the present disclosure are printers, facsimile machines, photocopiers, multi-function peripherals (serving as a printer, a facsimile machine, and a photocopier), 3D printers, etc.

In the present disclosure, the image forming apparatus and the image forming method respectively represent a device capable of discharging ink, various processing fluids, etc. to a recording medium and a method of conducting recording utilizing the apparatus. The recording medium means an article to which ink or various processing fluids can be attached even temporarily.

The recording device may further optionally include a device relating to feeding, conveying, and ejecting the recording medium and other devices referred to as a pre-processing device, a post-processing device, etc. in addition to the head portion to discharge the ink and the drying portion to emit infrared rays.

In addition, the recording device and the recording method are not limited to those producing meaningful visible images such as texts and figures with ink. For example, the recording method and the recording device capable of producing patterns like geometric design and 3D images are included.

The image forming apparatus is described with reference to drawings.

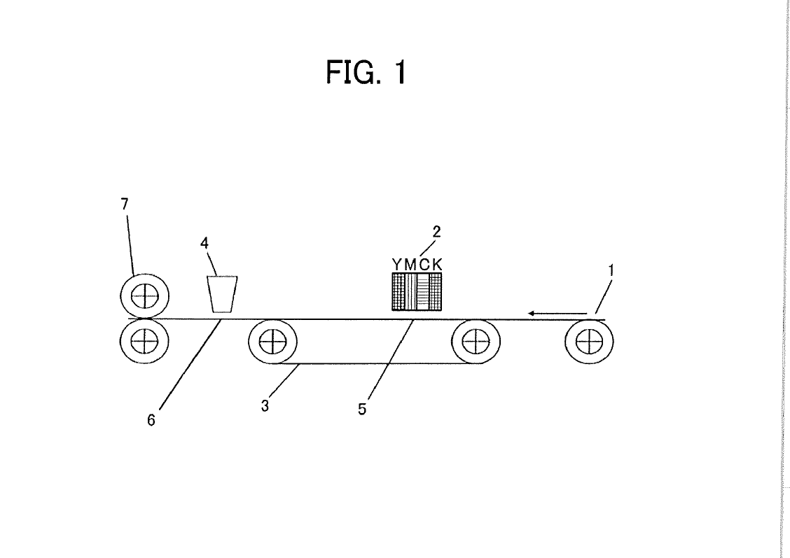

FIG. 1 is a schematic diagram illustrating an example of the image forming apparatus for use in the present disclosure.

In FIG. 1, the image forming apparatus includes an image forming device and a drying device. Reference numerals 1, 2, 3, 4, 5, 6, and 7 respectively represent a recording medium, an ink discharging unit, a conveyor belt, an infrared irradiator, an image forming unit, a drying processing unit, and a transfer roller.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### Examples

Next, the present disclosure is described in detail with reference to Examples but is not limited thereto.

The average vapor pressure p(A) and the average vapor pressure P(B) of each ink were measured in the following manner.

Average Vapor Pressure P(A) and Average Vapor Pressure P(B)

The average vapor pressure P(A) of water and an organic solvent in the ink A at 100 degrees C. and the average vapor pressure P(B) of water and an organic solvent in the ink B at 100 degrees C. were obtained according to the following relation 1.

Average vapor pressure={content (percent by mass) of water in ink}×{vapor pressure of water at 100 degrees C. (101.325 mmHg)}+{content (percent by mass) of organic solvent 1 in ink}×{vapor pressure (mmHg) of organic solvent 1 at 100 degrees C.}+{content (percent by mass) of organic solvent 2 in ink}×{vapor pressure (mmHg) of organic solvent 2 at 100 degrees C.}+•••+•••{content (percent by mass) of organic solvent n in ink}×{vapor pressure (mmHg) of organic solvent n at 100 degrees C.} Relation 1

Only the organic solvent accounting for 1.00 percent by mass of the total content of the ink was subject to the calculation of the average vapor pressure.

Synthesis Example of Copolymer

Synthesis of Monomer

62.0 g (525 mmol) of 1,6-hexanediol (manufactured by Tokyo Chemical Industry Co., Ltd.) was dissolved in 700 mL of dichloromethane (methylene chloride) and thereafter, 20.7 g (262 mmol) of pyridine was further added. To this solution, a solution in which 50.0 g (262 mmol) of 2-naphthalene carbonyl chloride (manufacture by Tokyo Chemical Industry Co., Ltd.) was dissolved in 100 mL of dichloromethane (methylene chloride) was dripped in two hours while being stirred followed by stirring at room temperature (25 degrees C.) for six hours. Subsequent to rinsing with water, an organic phase was isolated. Next, after drying the organic phase with magnesium sulfide, the solvent was distilled away. The resultant was refined by silica gel column chromatography (glass column: inner diameter 100 m×column height: 500 mm) and spherical silica gel 60N (neutral, manufactured by Kanto Chemical Co., Inc.) using a solvent mixture of methylene chloride and methanol with a volume ratio of 98 to 2) as an eluent to obtain 52.5 g of 2-naphthoic acid-2-hydroxyethyl ester.

Next, 42.1 g (155 mmol) of 2-naphthoic acid-2-hydroxyethyl ester was dissolved in 80 mL of dried methylethylketone followed by heating to 60 degrees C. Next, to this solution, a solution in which 24.0 g (155 mmol) of 2-methacryloyloxy ethylisocyanate (Karenz MOI, manufactured by SHOWA DENKO K.K.) was dissolved in 20 mL of dried methylketone was dripped in one hour while being stirred followed by stirring at 70 degrees C. for 12 hours. Moreover, subsequent to cooling down to room temperature (25 degrees C.), the solvent was distilled away. Thereafter, the resultant was refined by silica gel column chromatography with a solvent mixture of a methylene chloride and methanol with a volume ratio of 99:1 serving as an eluent to obtain 57.0 g of monomer M-1 represented by the following Chemical structure 1.

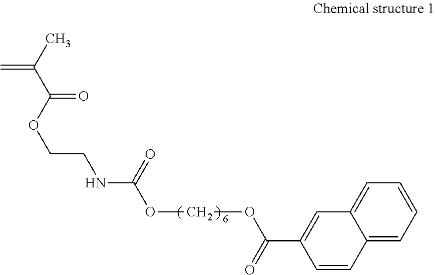

Synthesis of Copolymer R-1

3.80 g (52.7 mmol) of acrylic acid (manufactured by Sigma-Aldrich Corporation) and 11.26 g (26.3. mmol) of the monomer M-1 were dissolved in 75 mL of dried methylethyl ketone to prepare a monomer solution. Thereafter, 10 percent by mass of the monomer solution was heated to 75 degrees C. in an argon atmosphere. Thereafter, a solution in which 0.59 g (3.61 mmol) of 2,2′-azoisobutylonitrile (manufactured by Tokyo Chemical Industry Co., Ltd.) was dissolved in the rest (90 percent) of the monomer solution was dripped to the heated monomer solution in 1.5 hours followed by stirring at 75 degrees C. for four hours. The resultant was cooled down to room temperature (25 degrees C.) and the thus-obtained reaction solution was dripped to hexane to precipitate a copolymer. The precipitated copolymer was filtrated followed by drying with a reduced pressure to obtain 14.55 g of a copolymer R-1 (mass average molecular weight (Mw): 30,000).

5.00 g (amount of carboxylic group, 17.5 mmol) of the thus-obtained copolymer R-1 was weighed. Thereafter, 7.36 g (content of tetraethylammonium ion: 17.5 mmol) of 35 percent by mass of tetraethylammonium hydroxide aqueous solution (manufactured by Tokyo Chemical Industry Co. Ltd.) and 37.64 g of deionized water were admixed with the weighed copolymer R-1 followed by stirring to prepare 10 percent by mass aqueous solution of the copolymer R-1.

Preparation Example 1 of Pigment Dispersion

Preparation of Dispersion of Carbon Black

30.0 parts of carbon black (NIPEX160, manufactured by Evonik Industries AG) and 32.5 parts of deionized water were added to 37.5 parts of 10 percent by mass aqueous solution of the copolymer R-1 and stirred for 12 hours. Next, using a disk type bead mill (KDL type, manufactured by Shinmaru Enterprises Corporation), the resultant was subject to circulation dispersion at a peripheral speed of 10 m/s for one hour. The used media were zirconia balls having a diameter of 0.3 mm. Furthermore, subsequent to filtration by a membrane filter (Minisart, manufactured by Sartorius Japan) having an opening diameter of 1.2 deionized water was added in such a manner that the concentration of the pigment was 30 percent by mass to obtain a carbon black dispersion.

Preparation Example 2 of Pigment Dispersion

Preparation of Cyan Pigment Dispersion

A cyan pigment dispersion having a pigment concentration of 30 percent by mass was obtained in the same manner as in Preparation Example 1 of Pigment Dispersion except that carbon black was replaced with Pigment Blue 15:3 (CHROMOFINE BLUE, manufactured by Dainichiseika Color & Chemicals Mfg. Co., Ltd.).

Preparation Example 3 of Pigment Dispersion

Preparation of Magenta Pigment Dispersion

A magenta pigment dispersion having a pigment concentration of 30 percent by mass was obtained in the same manner as in Preparation Example 1 of Pigment Dispersion except that carbon black pigment was changed to Pigment Red 122 (Product: TONER MAGENTA EO02, manufactured by Clariant Japan K.K.).

Preparation Example 4 of Pigment Dispersion

Preparation of Yellow Pigment Dispersion

A yellow pigment dispersion having a pigment concentration of 30 percent by mass was obtained in the same manner as Preparation Example 1 of Pigment Dispersion except that carbon black was replaced with Pigment Yellow 74 (Product: FAST Yellow 531, manufactured by Dainichiseika Color & Chemicals Mfg. Co., Ltd.).

Preparation Example 5 of Pigment Dispersion

Preparation of Black Pigment Dispersion Using Black Pigment Other Than Carbon Black

A black pigment dispersion having a pigment concentration of 30 percent by mass was obtained in the same manner as in Preparation Example 1 of Pigment Dispersion except that carbon black was replaced with complex oxide-based black pigment (Product: Pigment Black27, manufactured by ASAHI KASEI KOGYO CO., LTD.)

Preparation Example of Water-dispersible Resin Dispersion

Preparation of Acrylic-Silicone Polymer Particle Dispersion

After sufficient replacement with nitrogen gas in a flask (1 L) equipped with a mechanical stirrer, a thermometer, a nitrogen gas introducing tube, a reflux tube, and a dripping funnel, 8.0 g of LATEMUL S-180 (reactive anionic surfactant, manufactured by Kao Corporation) was admixed with 350 g of deionized water and heated to 65 degrees C. Thereafter, 3.0 g of t-butylperoxy benzoate serving as reaction initiator and 1.0 g of sodium isoascorbiate were added to the mixture. Five minutes later, a mixture of 45 g of methylmethacrylate, 160 g of methacrylic acid-2-ethylhexyl, 5 g of acrylic acid, 45 g of butylmethacrylate, 30 g of cyclohexyl methacrylate, 15 g of vinyltriethoxysilane, 8.0 g of LATEMUL S-180, and 340 g of deionized water were dripped to the resultant in three hours. Subsequent to heating at 80 degrees C. for two-hour aging, the resultant was cooled down to room temperature (25 degrees C.). pH of the resultant was adjusted to 7-8 by sodium hydroxide. Thereafter, ethanol was distilled away by an evaporator followed by moisture adjustment to obtain 730 g of acrylic-silicone polymer particle dispersion having a concentration of a solid portion of 40 percent. In addition, the volume accumulation average particle diameter (D₅₀) of the polymer particle in the dispersion was 125 nm as measured by a particle size distribution measuring instrument (NANOTRAC UPA-EX150, manufactured by NIKKISO CO., LTD.).

Preparation Example 1 of Black Ink

Preparation of Black Ink 1

12.4 parts of 1,2-propane diol, 15.0 parts of 3-ethyl-3-hydroxy dimethyloxetane, 10.0 parts of 3-methyl-L3-butane diol, 2.0 parts of silicone surfactant 1 (polyether-modified siloxane copolymer, TEGO WET 270, manufactured by Evonik Industries AG) were charged in a container equipped with a stirrer and mixed and stirred for 30 minutes. Thereafter, 20.0 parts of carbon black dispersion and 35.6 parts of deionized water were added and mixed and stirred for 60 minutes. Moreover, 5.0 parts of acrylic-silicone polymer particle dispersion was added and mixed and stirred for 30 minutes. The thus-obtained mixture was filtrated under a pressure by a membrane filter (Minisart, manufactured by Sartorius Japan) having an average particle diameter of 1.2 μm and coarse particles and dusts were removed to obtain black ink 1.

Preparation Examples 2 to 18 of Black Ink

Preparation of Black Inks 2 to 18

Inks 2 to 18 were obtained in the same manner as in Preparation Example 1 of Black Ink except that the formulation was changed to those shown in Tables 1 and 2. The formulation was shown in Tables 1 and 2.

TABLE 1

| | | Black ink No. | | | | |
|---|---|---|---|---|---|---|
| | | 1 | 2 | 3 | 4 | 5 |
| Carbon | Carbon black | 20.00 | 20.00 | 20.00 | 20.00 | 20.00 |
| black | dispersion | | | | | |
| | (Pigment | | | | | |
| | concentration: | | | | | |
| | 30 percent by | | | | | |
| | mass) | | | | | |
| Black | Black pigment | — | — | — | — | — |
| pigment | dispersion | | | | | |
| other than | using black | | | | | |
| carbon | pigment other | | | | | |
| black | than carbon | | | | | |
| | black (pigment | | | | | |
| | concentration: | | | | | |
| | 30 percent by | | | | | |
| | mass) | | | | | |
| Water- | Acrylic- | 5.00 | 5.00 | 5.00 | 5.00 | 5.00 |
| dispersible | silicone | | | | | |
| Resin | polymer | | | | | |
| | particle | | | | | |
| | dispersion | | | | | |
| Organic | 1,2- | 12.40 | — | — | — | 10.00 |
| solvent | propanediol | | | | | |
| | 3-ethyl-3- | 15.00 | 30.00 | 15.00 | 31.00 | 15.00 |
| | hydroxymethyl | | | | | |
| | oxetane | | | | | |
| | 3-methyl-1,3- | 10.00 | 20.70 | 22.30 | 21.00 | 25.80 |
| | butane diol | | | | | |
| Surfactant | Silicone | 2.00 | — | 2.00 | 2.00 | 2.00 |
| | surfactant 1 | | | | | |
| | Silicone | — | 2.00 | — | — | — |
| | surfactant 2 | | | | | |
| Water | Deionized | Balance | Balance | Balance | Balance | Balance |
| | water | | | | | |

| | | | | | |
|---|---|---|---|---|---|
| Total (Percent by mass) | 100.0 | 100.0 | 100.0 | 100.0 | 100.0 |

| | | Black ink No. | | | |
|---|---|---|---|---|---|
| | | 6 | 7 | 8 | 9 |
| Carbon | Carbon black | 20.00 | 20.00 | 3.00 | 3.33 |
| black | dispersion | | | | |
| | (Pigment | | | | |
| | concentration: | | | | |
| | 30 percent by | | | | |
| | mass) | | | | |
| Black | Black pigment | — | — | — | — |
| pigment | dispersion | | | | |
| other than | using black | | | | |
| carbon | pigment other | | | | |
| black | than carbon | | | | |
| | black (pigment | | | | |
| | concentration: | | | | |
| | 30 percent by | | | | |
| | mass) | | | | |
| Water- | Acrylic- | 5.00 | 5.00 | 21.59 | 21.56 |
| dispersible | silicone | | | | |
| Resin | polymer | | | | |
| | particle | | | | |
| | dispersion | | | | |
| Organic | 1,2- | 4.85 | 3.00 | 15.50 | 11.40 |
| solvent | propanediol | | | | |
| | 3-ethyl-3- | 7.00 | 3.90 | 12.00 | 15.00 |
| | hydroxymethyl | | | | |
| | oxetane | | | | |
| | 3-methyl-1,3- | — | 3.00 | 9.00 | 10.00 |
| | butane diol | | | | |
| Surfactant | Silicone | 2.00 | 2.00 | 2.00 | 2.00 |
| | surfactant 1 | | | | |
| | Silicone | — | — | — | — |
| | surfactant 2 | | | | |
| Water | Deionized | Balance | Balance | Balance | Balance |
| | water | | | | |

| | | | | |
|---|---|---|---|---|
| Total (Percent by mass) | 100.0 | 100.0 | 100.0 | 100.0 |

TABLE 2

| | | Black ink No. | | | | |
|---|---|---|---|---|---|---|
| | | 10 | 11 | 12 | 13 | 14 |
| Carbon | Carbon black | 33.33 | 36.67 | 1.50 | 1.67 | 63.33 |
| black | dispersion | | | | | |
| | (Pigment | | | | | |
| | concentration: | | | | | |
| | 30 percent by | | | | | |
| | mass) | | | | | |
| Black | Black pigment | — | — | — | — | — |
| Pigment | dispersion | | | | | |
| Other | using black | | | | | |
| Than | pigment other | | | | | |
| Carbon | than carbon | | | | | |
| Black | black (pigment | | | | | |
| | concentration: | | | | | |
| | 30 percent by | | | | | |
| | mass) | | | | | |
| Water- | Acrylic- | 1.25 | 0.94 | 20.00 | 20.00 | — |
| dispersible | silicone | | | | | |
| Resin | polymer | | | | | |
| | particle | | | | | |
| | dispersion | | | | | |
| Organic | 1,2- | 12.40 | 11.50 | 14.00 | 14.60 | 10.00 |
| solvent | propanediol | | | | | |
| | 3-ethyl-3- | 14.00 | 11.90 | 12.00 | 15.00 | — |
| | hydroxymethyl | | | | | |
| | oxetane | | | | | |
| | 3-methyl-1,3- | 8.00 | 10.00 | 11.70 | 8.00 | 7.50 |
| | butane diol | | | | | |
| Surfactant | Silicone | 2.00 | 2.00 | — | 2.00 | — |
| | surfactant 1 | | | | | |
| | Silicone | — | — | 2.00 | — | — |
| | surfactant 2 | | | | | |
| Water | Deionized | Balance | Balance | Balance | Balance | Balance |
| | water | | | | | |

| | | | | | |
|---|---|---|---|---|---|
| Total (Percent by mass) | 100.0 | 100.0 | 100.0 | 100.0 | 100.0 |

| | | Black ink No. | | | |
|---|---|---|---|---|---|
| | | 15 | 16 | 17 | 18 |
| Carbon | Carbon black | 70.00 | 20.00 | 20.00 | — |
| black | dispersion | | | | |
| | (Pigment | | | | |
| | concentration: | | | | |
| | 30 percent by | | | | |
| | mass) | | | | |
| Black | Black pigment | — | — | — | 20.00 |
| Pigment | dispersion | | | | |
| Other | using black | | | | |
| Than | pigment other | | | | |
| Carbon | than carbon | | | | |
| Black | black (pigment | | | | |
| | concentration: | | | | |
| | 30 percent by | | | | |
| | mass) | | | | |
| Water- | Acrylic- | — | 5.00 | 5.00 | 5.00 |
| dispersible | silicone | | | | |
| Resin | polymer | | | | |
| | particle | | | | |
| | dispersion | | | | |
| Organic | 1,2- | 5.00 | 4.50 | 19.20 | 12.40 |
| solvent | propanediol | | | | |
| | 3-ethyl-3- | 9.00 | 3.00 | 15.00 | 15.00 |
| | hydroxymethyl | | | | |
| | oxetane | | | | |
| | 3-methyl-1,3- | — | 3.00 | 20.00 | 10.00 |
| | butane diol | | | | |
| Surfactant | Silicone | 2.00 | 2.00 | — | 2.00 |
| | surfactant 1 | | | | |
| | Silicone | — | — | 2.00 | — |
| | surfactant 2 | | | | |
| Water | Deionized | Balance | Balance | Balance | Balance |
| | water | | | | |

| | | | | |
|---|---|---|---|---|
| Total (Percent by mass) | 100.0 | 100.0 | 100.0 | 100.0 |

Preparation Example 1 of Cyan Ink

Preparation of Cyan Ink 1

Cyan ink 1 was obtained in the same manner as in Preparation Example 1 of Black Ink except that the formulation was changed to those shown in Table 3. The formulation was shown in Table 3.

TABLE 3

| | | Cyan ink No. |
|---|---|---|
| | | 1 |
| Pigment other | Cyan pigment dispersion | 10.00 |
| than carbon | (Pigment concentration: | |
| black | 30 percent by mass) | |
| Water- | Acrylic-silicone polymer | 10.00 |
| dispersible | particle dispersion | |
| Resin | | |
| Organic | 1,2-propanediol | 10.80 |
| solvent | 3-ethyl-3-hydroxymethyl | 15.00 |
| | oxetane | |
| | 3-methyl-1,3-butane diol | 11.00 |
| Surfactant | Silicone surfactant 1 | 2.00 |
| Water | Deionized water | Balance |

| | |
|---|---|
| Total (Percent by mass) | 100.0 |

Preparation Example 1 of Magenta Ink

Preparation of Magenta Ink 1

Magenta ink 1 was obtained in the same manner as in Preparation Example 1 of Black Ink except that the formulation was changed to that shown in Table 4. The formulation was shown in Table 4.

TABLE 4

| | | Magenta |
|---|---|---|
| | | ink No. |
| | | 1 |
| Pigment other | Magenta pigment dispersion | 16.67 |
| than carbon | (Pigment concentration: | |
| black | 30 percent by mass) | |
| Water- | Acrylic-silicone polymer | 7.50 |
| dispersible | particle dispersion | |
| Resin | | |
| Organic | 1,2-propanediol | 10.50 |
| solvent | 3-ethyl-3-hydroxymethyl | 12.00 |
| | oxetane | |
| | 3-methyl-1,3-butane diol | 11.00 |
| Surfactant | Silicone surfactant 1 | 2.00 |
| Water | Deionized water | Balance |

| | |
|---|---|
| Total (Percent by mass) | 100.0 |

Preparation Examples 1 to 17 of Yellow Ink

Preparation of Yellow Inks 1 to 17

Inks 1 to 17 were obtained in the same manner as in Preparation Example 1 of Black Ink except that the formulation was changed to those shown in Tables 5 and 6. The formulation was shown in Tables 5 and 6.

TABLE 5

| | | Yellow ink No. | | | | |
|---|---|---|---|---|---|---|
| | | 1 | 2 | 3 | 4 | 5 |
| Pigment | Yellow | 10.00 | 10.00 | 10.00 | 10.00 | 10.00 |
| other than | pigment | | | | | |
| carbon | dispersion | | | | | |
| black | (Pigment | | | | | |
| | concentration: | | | | | |
| | 30 percent by | | | | | |
| | mass) | | | | | |
| Water- | Acrylic- | 10.00 | 10.00 | 10.00 | 10.00 | 10.00 |
| dispersible | silicone | | | | | |
| Resin | polymer | | | | | |
| | particle | | | | | |
| | dispersion | | | | | |
| Organic | 1,2- | 12.10 | — | 19.60 | 18.00 | 11.80 |
| solvent | propanediol | | | | | |
| | 3-ethyl-3- | 15.00 | 13.20 | 5.00 | 20.00 | 16.00 |
| | hydroxymethyl | | | | | |
| | oxetane | | | | | |
| | 3-methyl-1,3- | 10.00 | — | 15.00 | 16.00 | 24.80 |
| | butane diol | | | | | |
| Surfactant | Silicone | 1.00 | 1.00 | 1.00 | 1.00 | 1.00 |
| | surfactant 1 | | | | | |
| | Silicone | — | — | — | — | — |
| | surfactant 2 | | | | | |
| Water | Deionized | Balance | Balance | Balance | Balance | Balance |
| | water | | | | | |

| | | | | | |
|---|---|---|---|---|---|
| Total (Percent by mass) | 100.0 | 100.0 | 100.0 | 100.0 | 100.0 |

| | | Yellow ink No. | | | |
|---|---|---|---|---|---|
| | | 6 | 7 | 8 | 9 |
| Pigment | Yellow | 10.00 | 10.00 | 3.33 | 3.33 |
| other than | pigment | | | | |
| carbon | dispersion | | | | |
| black | (Pigment | | | | |
| | concentration: | | | | |
| | 30 percent by | | | | |
| | mass) | | | | |
| Water- | Acrylic- | 10.00 | 10.00 | 20.00 | 20.00 |
| dispersible | silicone | | | | |
| Resin | polymer | | | | |
| | particle | | | | |
| | dispersion | | | | |
| Organic | 1,2- | 5.00 | 4.60 | 10.40 | 10.00 |
| solvent | propanediol | | | | |
| | 3-ethyl-3- | 5.00 | 4.00 | 15.00 | 15.40 |
| | hydroxymethyl | | | | |
| | oxetane | | | | |
| | 3-methyl-1,3- | 3.60 | 3.00 | 10.00 | 10.00 |
| | butane diol | | | | |
| Surfactant | Silicone | 1.00 | 1.00 | 1.00 | 1.00 |
| | surfactant 1 | | | | |
| | Silicone | — | — | — | — |
| | surfactant 2 | | | | |
| Water | Deionized | Balance | Balance | Balance | Balance |
| | water | | | | |

| | | | | |
|---|---|---|---|---|
| Total (Percent by mass) | 100.0 | 100.0 | 100.0 | 100.0 |

TABLE 6

| | | Yellow ink No. | | | |
|---|---|---|---|---|---|
| | | 10 | 11 | 12 | 13 |
| Pigment | Yellow | 3.33 | 3.33 | 1.43 | 1.73 |
| other than | pigment | | | | |
| carbon | dispersion | | | | |
| black | (Pigment | | | | |
| | concentration: | | | | |
| | 30 percent by | | | | |
| | mass) | | | | |
| Water- | Acrylic- | 17.50 | 17.50 | 12.50 | 12.50 |
| dispersible | silicone | | | | |
| Resin | polymer | | | | |
| | particle | | | | |
| | dispersion | | | | |
| Organic | 1,2- | 12.00 | 11.40 | 12.10 | — |
| solvent | propanediol | | | | |
| | 3-ethyl-3- | 14.40 | 15.00 | 15.00 | 15.00 |
| | hydroxymethyl | | | | |
| | oxetane | | | | |
| | 3-methyl-1,3- | 10.00 | 10.00 | 12.00 | 5.10 |
| | butane diol | | | | |
| Surfactant | Silicone | 1.00 | — | 1.00 | 1.00 |
| | surfactant 1 | | | | |
| | Silicone | — | 1.00 | — | — |
| | surfactant 2 | | | | |
| Water | Deionized | Balance | Balance | Balance | Balance |
| | water | | | | |
| Total (Percent by mass) | | 100.0 | 100.0 | 100.0 | 100.0 |
| | | Yellow ink No. | | | |
| | | 14 | 15 | 16 | 17 |
| Pigment | Yellow | 65.67 | 70.00 | 10.00 | 10.00 |
| other than | pigment | | | | |
| carbon | dispersion | | | | |
| black | (Pigment | | | | |
| | concentration: | | | | |
| | 30 percent by | | | | |
| | mass) | | | | |
| Water- | Acrylic- | — | — | 10.00 | 10.00 |
| dispersible | silicone | | | | |
| Resin | polymer | | | | |
| | particle | | | | |
| | dispersion | | | | |
| Organic | 1,2- | 0.20 | 5.70 | 1.00 | 5.00 |
| solvent | propanediol | | | | |
| | 3-ethyl-3- | — | — | 1.00 | 5.00 |
| | hydroxymethyl | | | | |
| | oxetane | | | | |
| | 3-methyl-1,3- | — | 10.00 | 12.50 | 3.60 |
| | butane diol | | | | |
| Surfactant | Silicone | — | — | 1.00 | 1.00 |
| | surfactant 1 | | | | |
| | Silicone | — | — | — | — |
| | surfactant 2 | | | | |
| Water | Deionized | Balance | Balance | Balance | Balance |
| | water | | | | |

| | | | | |
|---|---|---|---|---|
| Total (Percent by mass) | 100.0 | 100.0 | 100.0 | 100.0 |

In Tables 1 to 6, the product names and the manufacturing companies of the ingredients are as follows:

1,2-propane diol, manufactured by Tokyo Chemical Industry Co. Ltd.

3-ethyl-3-hydroxymethyl oxetane ma Ube Industries, Ltd.

3-methyl-1,3-butane diol, manufactured by Tokyo Chemical Industry Co. Ltd.

Silicone surfactant 1: polyether-modified siloxane copolymer, TEGO WET 270, manufactured by Evonik Industries AG

Silicone surfactant 2: polyether-modified silicone surfactant, Silface SAG 503A, manufactured by Nisshin Chemical Co., Ltd.
Combination 1 of Ink Set
Combination of Ink Set 1
Black ink 1 as ink A and yellow ink 1 as ink B were combined to set an ink set 1.
Combinations 2 to 20 of Ink Set
Combinations of Ink Set 2 to 20

In the Combination 1 of Ink Set 1, Ink Sets 2 to 20 were set in the same manner as in the combination 1 of the Ink Set except that the combinations were changed as shown in Table 7.

Next, using the thus-obtained Ink Set, the vapor pressure P of each ink at 100 degrees C., the average vapor pressure ratio P(B)/P(A), the mass ratio X(A) of the content of the pigment contained in the ink A to the total content of water and the organic solvent contained in the ink A, the mass ratio X(B) of the content of the pigment contained in the ink B to the total content of water and the organic solvent contained in the ink B, and the ratio X(A)/X(B) were calculated. The results are shown in Table 7.

TABLE 7

| | | | | Average vapor pressure | | Average vapor |
|---|---|---|---|---|---|---|
| | | | | P(A) | P(B) | pressure ratio |
| | | Ink A | Ink B | (mmHg) | (mmHg) | (P(B)/P(A) |
| Ink set | 1 | Black | Yellow | 400 | 420 | 1.05 |
| | | ink 1 | ink 1 | | | |
| | 2 | Black | Yellow | 300 | 598 | 1.99 |
| | | ink 2 | ink 2 | | | |
| | 3 | Black | Yellow | 400 | 402 | 1.01 |
| | | ink 3 | ink 3 | | | |
| | 4 | Black | Cyan | 400 | 415 | 1.04 |
| | | ink 1 | ink 1 | | | |
| | 5 | Black | Magenta | 400 | 430 | 1.07 |
| | | ink 1 | ink 1 | | | |
| | 6 | Black | Yellow | 290 | 295 | 1.01 |
| | | ink 4 | ink 4 | | | |
| | 7 | Black | Yellow | 300 | 305 | 1.02 |
| | | ink 5 | ink 5 | | | |
| | 8 | Black | Yellow | 590 | 595 | 1.01 |
| | | ink 6 | ink 6 | | | |
| | 9 | Black | Yellow | 605 | 610 | 1.01 |
| | | ink 7 | ink 7 | | | |
| | 10 | Black | Yellow | 400 | 420 | 1.05 |
| | | ink 8 | ink 8 | | | |
| | 11 | Black | Yellow | 400 | 420 | 1.05 |
| | | ink 9 | ink 9 | | | |
| | 12 | Black | Yellow | 400 | 420 | 1.05 |
| | | ink 10 | ink 10 | | | |
| | 13 | Black | Yellow | 399 | 420 | 1.05 |
| | | ink 11 | ink 11 | | | |
| | 14 | Black | Yellow | 400 | 420 | 1.05 |
| | | ink 12 | ink 12 | | | |
| | 15 | Black | Yellow | 400 | 560 | 1.40 |
| | | ink 13 | ink 13 | | | |
| | 16 | Black | Yellow | 468 | 590 | 1.26 |
| | | ink 14 | ink 14 | | | |
| | 17 | Black | Yellow | 461 | 464 | 1.01 |
| | | ink 15 | ink 15 | | | |
| | 18 | Black | Yellow | 600 | 588 | 0.98 |
| | | ink 16 | ink 16 | | | |
| | 19 | Black | Yellow | 275 | 595 | 2.16 |
| | | ink 17 | ink 17 | | | |
| | 20 | Black | Yellow | 400 | 420 | 1.05 |
| | | ink 18 | ink 1 | | | |

| | | | | Mass ratio of pigment contained in ink A | | |
|---|---|---|---|---|---|---|
| | | | | (B) to total content of water and organic | | |
| | | | | solvent contained in ink A(B) | | |
| | | | | X(A) (percent | X(B) (percent | Ratio |
| | | Ink A | Ink B | by mass) | by mass) | X(A)/X(B) |
| Ink set | 1 | Black | Yellow | 6.723 | 3.274 | 2.053 |
| | | ink 1 | ink 1 | | | |
| | 2 | Black | Yellow | 6.723 | 3.274 | 2.053 |
| | | ink 2 | ink 2 | | | |
| | 3 | Black | Yellow | 6.723 | 3.274 | 2.053 |
| | | ink 3 | ink 3 | | | |
| | 4 | Black | Cyan | 6.723 | 3.310 | 2.031 |
| | | ink 1 | ink 1 | | | |
| | 5 | Black | Magenta | 6.723 | 5.594 | 1.202 |
| | | ink 1 | ink 1 | | | |
| | 6 | Black | Yellow | 6.723 | 3.274 | 2.053 |
| | | ink 4 | ink 4 | | | |
| | 7 | Black | Yellow | 6.723 | 3.274 | 2.053 |
| | | ink 5 | ink 5 | | | |
| | 8 | Black | Yellow | 6.723 | 3.274 | 2.053 |
| | | ink 6 | ink 6 | | | |
| | 9 | Black | Yellow | 6.723 | 3.274 | 2.053 |
| | | ink 7 | ink 7 | | | |
| | 10 | Black | Yellow | 1.019 | 1.112 | 0.916 |
| | | ink 8 | ink 8 | | | |
| | 11 | Black | Yellow | 1.132 | 1.111 | 1.018 |
| | | ink 9 | ink 9 | | | |
| | 12 | Black | Yellow | 11.594 | 1.099 | 10.547 |
| | | ink 10 | ink 10 | | | |
| | 13 | Black | Yellow | 12.904 | 1.099 | 11.739 |
| | | ink 11 | ink 11 | | | |
| | 14 | Black | Yellow | 0.503 | 0.459 | 1.096 |
| | | ink 12 | ink 12 | | | |

Creation of Evaluation Diagram

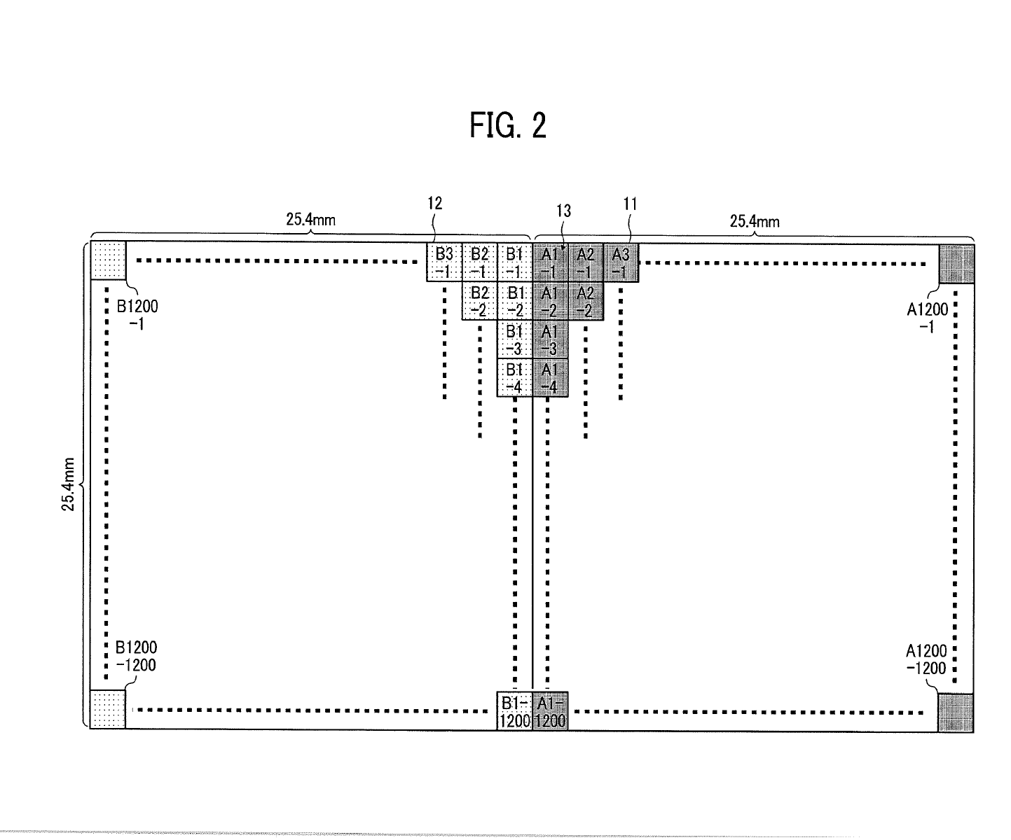

Using thus-obtained each ink set, the evaluation diagram illustrated in FIG. 2 was created. FIG. 2 is a schematic diagram illustrating an example of the evaluation diagram having a recording resolution of 1,200 dpi×1,200 dpi. Specifically, in the environment of 23 degrees C. and 50 percent RH, an evaluation diagram having a recording resolution of 1,200 dpi×1,200 dpi was printed on one side thereof using a piezoelectric recording head employing a shuttle head method with a nozzle diameter of 22 μm and a number of nozzles of 1,280. “dpi” means the number of dots per 2.54 cm. In addition, the recording medium used was MyPaper (plain paper, manufactured by Ricoh Company Ltd.), LumiArt gloss 90 gsm (coated paper 1, manufactured by Mondi plc), and OK topcoat+(coated paper 2, weight 73.3 g/cm², manufactured by OJI PAPER CO., LTD.).

In the evaluation diagram illustrated in FIG. 2, the number of dots per droplet and the amount of pigment attached were adjusted in order that the attached amount of Ink A and Ink B were as shown in Table 8. Regarding preparation of the number of dots 11 of Ink A, the number of dots was adjusted by increasing the number of dots in the following sequence: A1-1, A1-2,•••A1-120, A2-1, A2-2,•••A1200-1200. The number of dots of Ink B was adjusted in the same manner as Ink A. The reference numeral 13 in FIG. 2 represents a dot, the reference numeral 11 represents a dot of Ink A, and the reference numeral 12 represents a dot of Ink B.

Within 5 seconds of the completion of printing, the print surface was irradiated with infrared rays emitted from an infrared heater disposed 4 cm above the print surface for the period of time shown in Table 8 to create a print chart for evaluation. The temperature of the infrared heater was shown in Table 8. The temperature of the heat source and the drying time were shown in Table 8. When the temperature of the heat source was 190 or 200 degrees C., a far infrared ceramic chameleon heater (manufactured by SAKAGUCHI E.H VOC CORP.) was used. When the temperature of the heat source was 1,000, 1,300, or 1,310 degrees C., high output carbon heater (manufactured by METRO DENKI KOGYO Co., Ltd.) was used. The voltage applied to the heater was changed to adjust the temperature of the heat source. The temperature of the heat source was measured by a digital radiation temperature sensor FT-H50K (manufactured by KEYENCE CORPORATION). Regarding the high output carbon heater, carbon serving as the heat source was encapsulated into a glass tube so that the temperature of the glass tube was measured to infer the temperature of the carbon. 10 seconds after irradiation of infrared rays, it is possible to use a warm air drier to heat the evaluation diagram with heated wind for 15 seconds. The wind speed of the drier was 20 m/s and the temperature of the heated wind was 100 degrees C. The temperature of the heated wind was measured by K type thermocouple (front end welding type, line diameter: 0.2 mm, manufactured by ThreeHigh Co., Ltd.). The K type thermocouple was brought into contact with the recording medium to measure the temperature of heated wind. The attachment amount of pigment per unit of area of ink A and ink B and other conditions are shown in Table 8.

As for the content W(A) and the content W(B) of the pigment and the content ratio {W(A)/W(B)}, an area of 1 cm×1 cm in an image was defined as the unit of area.

Specific examples of the calculation is that the attachment amount of carbon black and pigments other than carbon black in an area of 25.4 mm×50.8 mm in an image were obtained and the obtained results were divided by the area of 25.4 mm×50.8 mm to obtain the content W(A) and the content W(B) per 1 cm×1 cm. Thereafter, W(A)/W(B) was calculated.

TABLE 8

| | | | Content of pigment | | Content | Attachment Amount of Ink | |
|---|---|---|---|---|---|---|---|
| | | Ink set | W(A) | W(B) | ratio | Ink A | Ink B |
| | | No. | (μg/cm²) | (μg/cm²) | W(A)/W(B) | (μg/cm²) | (μg/cm²) |
| Example | 1 | 1 | 10.000 | 5.000 | 2.000 | 166.67 | 166.67 |
| | 2 | 2 | 7.500 | 7.500 | 1.000 | 125.00 | 250.00 |
| | 3 | 3 | 14.850 | 0.150 | 99.000 | 247.50 | 5.00 |
| | 4 | 4 | 10.000 | 5.000 | 2.000 | 166.67 | 166.67 |
| | 5 | 5 | 10.000 | 5.000 | 2.000 | 166.67 | 100.00 |
| | 6 | 1 | 10.000 | 5.000 | 2.000 | 166.67 | 166.67 |
| | 7 | 1 | 10.000 | 5.000 | 2.000 | 166.67 | 166.67 |
| | 8 | 1 | 10.000 | 5.000 | 2.000 | 166.67 | 166.67 |
| | 9 | 1 | 10.000 | 5.000 | 2.000 | 166.67 | 166.67 |
| | 10 | 1 | 10.000 | 5.000 | 2.000 | 166.67 | 166.67 |
| | 11 | 1 | 10.000 | 5.000 | 2.000 | 166.67 | 166.67 |
| | 12 | 1 | 10.000 | 5.000 | 2.000 | 166.67 | 166.67 |
| | 13 | 1 | 10.000 | 5.000 | 2.000 | 166.67 | 166.67 |
| | 14 | 1 | 10.000 | 5.000 | 2.000 | 166.67 | 166.67 |
| | 15 | 6 | 10.000 | 5.000 | 2.000 | 166.67 | 166.67 |
| | 16 | 7 | 10.000 | 5.000 | 2.000 | 166.67 | 166.67 |
| | 17 | 8 | 10.000 | 5.000 | 2.000 | 166.67 | 166.67 |
| | 18 | 9 | 10.000 | 5.000 | 2.000 | 166.67 | 166.67 |
| | 19 | 10 | 10.000 | 5.000 | 2.000 | 1,111.11 | 500.05 |
| | 20 | 11 | 10.000 | 5.000 | 2.000 | 1,001.00 | 500.50 |
| | 21 | 12 | 10.000 | 5.000 | 2.000 | 100.00 | 500.50 |
| | 22 | 13 | 10.000 | 5.000 | 2.000 | 90.90 | 500.50 |
| | 23 | 14 | 10.000 | 5.000 | 2.000 | 2,222.22 | 1,165.50 |
| | 24 | 15 | 10.000 | 5.000 | 2.000 | 1,996.01 | 963.39 |
| | 25 | 16 | 10.000 | 5.000 | 2.000 | 52.63 | 25.38 |
| | 26 | 17 | 10.000 | 5.000 | 2.000 | 47.62 | 23.81 |
| | 27 | 1 | 1.200 | 0.200 | 6.000 | 20.00 | 6.67 |
| | 28 | 1 | 1.500 | 0.300 | 5.000 | 25.00 | 10.00 |
| | 29 | 1 | 1,200.000 | 400.000 | 3.000 | 20,000.00 | 13,333.33 |
| | 30 | 1 | 1,400.000 | 300.000 | 4.667 | 23,333.33 | 10,000.00 |
| | 31 | 1 | 30.000 | 0.500 | 60.000 | 500.00 | 16.67 |
| Comparative | 1 | 18 | 10.000 | 5.000 | 2.000 | 166.67 | 166.67 |
| Example | 2 | 19 | 10.000 | 5.000 | 2.000 | 166.67 | 166.67 |
| | 3 | 1 | 7.400 | 7.600 | 0.974 | 123.33 | 253.33 |
| | 4 | 1 | 15.000 | 0.145 | 103.448 | 250.00 | 4.83 |
| | 5 | 1 | 5.000 | 10.000 | 0.500 | 83.33 | 333.33 |
| | 6 | 20 | 10.000 | 5.000 | 2.000 | 166.67 | 166.67 |

| | | | Attachment amount | Drying | Drying | Temperature of |
|---|---|---|---|---|---|---|
| | | Ink set | of pigment per | time | temperature | heated wind |
| | | No. | unit of area | (seconds) | (degrees C.) | (degrees C.) |
| Example | 1 | 1 | 9.356 | 6.0 | 1,000 | 100 |
| | 2 | 2 | 9.356 | 6.0 | 1,000 | 100 |
| | 3 | 3 | 9.356 | 6.0 | 1,000 | 100 |
| | 4 | 4 | 9.356 | 6.0 | 1,000 | 100 |
| | 5 | 5 | 9.356 | 6.0 | 1,000 | 100 |
| | 6 | 1 | 9.356 | 6.0 | 1,000 | — |
| | 7 | 1 | 9.356 | 6.0 | 190 | 100 |
| | 8 | 1 | 9.356 | 6.0 | 200 | 100 |
| | 9 | 1 | 9.356 | 6.0 | 1,300 | 100 |
| | 10 | 1 | 9.356 | 6.0 | 1,310 | 100 |
| | 11 | 1 | 9.356 | 0.8 | 1,000 | 100 |
| | 12 | 1 | 9.356 | 1.0 | 1,000 | 100 |
| | 13 | 1 | 9.356 | 30.0 | 1,000 | 100 |
| | 14 | 1 | 9.356 | 31.0 | 1,000 | 100 |
| | 15 | 6 | 9.356 | 6.0 | 1,000 | 100 |
| | 16 | 7 | 9.356 | 6.0 | 1,000 | 100 |
| | 17 | 8 | 9.356 | 6.0 | 1,000 | 100 |
| | 18 | 9 | 9.356 | 6.0 | 1,000 | 100 |
| | 19 | 10 | 9.356 | 6.0 | 1,000 | 100 |
| | 20 | 11 | 9.356 | 6.0 | 1,000 | 100 |
| | 21 | 12 | 9.356 | 6.0 | 1,000 | 100 |
| | 22 | 13 | 9.356 | 6.0 | 1,000 | 100 |
| | 23 | 14 | 9.356 | 6.0 | 1,000 | 100 |
| | 24 | 15 | 9.356 | 6.0 | 1,000 | 100 |
| | 25 | 16 | 9.356 | 6.0 | 1,000 | 100 |
| | 26 | 17 | 9.356 | 6.0 | 1,000 | 100 |
| | 27 | 1 | 0.873 | 6.0 | 1,000 | 100 |
| | 28 | 1 | 1.123 | 6.0 | 1,000 | 100 |
| | 29 | 1 | 997.920 | 6.0 | 1,000 | 100 |
| | 30 | 1 | 1060.290 | 6.0 | 1,000 | 100 |
| | 31 | 1 | 19.023 | 6.0 | 1,000 | 100 |
| Comparative | 1 | 18 | 9.356 | 6.0 | 1,000 | 100 |
| Example | 2 | 19 | 9.356 | 6.0 | 1,000 | 100 |
| | 3 | 1 | 9.356 | 6.0 | 1,000 | 100 |
| | 4 | 1 | 9.446 | 6.0 | 1,000 | 100 |
| | 5 | 1 | 9.356 | — | — | 100 |
| | 6 | 20 | 9.356 | 6.0 | 1,000 | 100 |

Next, the thus-obtained evaluation diagram was subject to evaluation of drying property, anti-kogation property, and anti-blister property. The results are shown in Table 9.

Drying Property

After outputting the evaluation diagram according to the printing and drying method described above, non-printed paper of MyPaper (plain paper, manufactured by Ricoh Company Ltd.), LumiArt gloss 90 gsm (coated paper 1, manufactured by Mondi plc), and OK topcoat+(coated paper 2, weight 73.3 g/cm², manufactured by OJI PAPER CO., LTD.) (3.0 cm×3.0 cm) was placed on the image portion separately. Thereafter, a rubber sheet of 3 cm×3 cm having a thickness of 0.2 cm was disposed thereon. A weight was placed on the rubber sheet in such a manner that the pressure from the rubber sheet to the evaluation diagram was 0.5 kgf/cm². Thereafter, the evaluation diagram was left at 23 degrees C. and 50 percent RH for 12 hours. Thereafter, the paper was peeled off and the degree of transfer of the pigment to the non-printed paper was visually observed and evaluated according to the following evaluation criteria.

Evaluation Criteria

AA: Transfer of pigment to paper never or little observed and no attachment of paper to each other

A: Transfer of pigment to paper never or little observed and paper was attached to each other

B: Transfer of pigment to paper slightly observed (less than 10 percent area of the entire paper transferred)

C: Transfer of pigment to paper clearly observed (not less than 10 percent area of the entire paper transferred)

Anti-Blister Property

The degree of blister of the obtained evaluation diagram was observed visually or with a magnifying glass. Anti-blister property was evaluated according to the following evaluation criteria.

Evaluation Criteria

AA: No blister recognized on print surface and opposite surface of evaluation diagram

A: No blister visually recognized on print surface and opposite surface of evaluation diagram but blister recognized at one site with a magnifying glass with a magnifying power of 10×.

B: No blister visually recognized on print surface and opposite surface of evaluation diagram but blister recognized at two or more sites with a magnifying glass with a magnifying power of 10×.

C: Blister visually recognized on print surface and opposite surface of evaluation diagram

Anti-Kogation

The evaluation diagram was visually observed and L* was measured by a reflection spectrodensitometer (X-Rite 938, manufactured by X-Rite). The absolute value of the difference between L* before drying (irradiation of infrared rays) and L* after drying was calculated and anti-kogation property was evaluated according to the following evaluation criteria.

Evaluation Criteria

AA: Absolute value of difference between L* before drying and L* after drying was less than 0.5

A: Absolute value of difference between L* before drying and L* after drying was from 0.5 to less than 1.0

B: Absolute value of difference between L* before drying and L* after drying was from 1.0 to less than 2.0

C: Absolute value of difference between L* before drying and L* after drying was 2.0 or greater, or image portion deformed or partially lost

TABLE 9

| | | Evaluation Results | | | | | | |
|---|---|---|---|---|---|---|---|---|
| | | Drying Property | | | Anti-kogation | | Anti-Blister | |
| | | Plain | Coated | Coated | Coated | Coated | Coated | Coated |
| | | paper | paper 1 | paper 2 | paper 1 | paper 2 | paper 1 | paper 2 |
| Example | 1 | AA | AA | AA | AA | AA | AA | AA |
| | 2 | AA | AA | AA | AA | AA | AA | AA |
| | 3 | AA | AA | AA | AA | AA | AA | AA |
| | 4 | AA | AA | AA | AA | AA | AA | AA |
| | 5 | AA | AA | AA | AA | AA | AA | AA |
| | 6 | AA | AA | AA | AA | A | AA | AA |
| | 7 | A | A | B | AA | AA | AA | AA |
| | 8 | AA | A | A | AA | AA | AA | AA |
| | 9 | AA | AA | AA | A | A | AA | AA |
| | 10 | AA | AA | AA | A | A | AA | B |
| | 11 | B | B | B | AA | AA | AA | AA |
| | 12 | A | B | B | AA | AA | AA | AA |
| | 13 | AA | AA | AA | A | A | A | A |
| | 14 | AA | AA | AA | B | A | A | A |
| | 15 | A | A | B | A | A | AA | A |
| | 16 | A | A | A | A | A | AA | A |
| | 17 | A | AA | A | A | A | A | A |
| | 18 | A | AA | A | A | B | A | A |
| | 19 | A | A | A | B | B | A | A |
| | 20 | A | A | A | A | B | A | A |
| | 21 | A | A | B | A | A | A | A |
| | 22 | A | B | B | A | A | A | A |
| | 23 | B | B | B | A | B | A | A |
| | 24 | B | B | A | A | B | A | A |
| | 25 | A | A | A | B | B | A | B |
| | 26 | A | A | A | B | B | B | B |
| | 27 | A | B | B | B | B | B | B |
| | 28 | A | A | B | B | B | B | B |
| | 29 | B | B | B | B | B | A | A |
| | 30 | B | B | B | B | B | A | B |
| | 31 | AA | AA | AA | AA | AA | A | AA |
| Comparative | 1 | C | C | C | B | B | B | B |
| Example | 2 | C | C | C | C | C | C | C |
| | 3 | C | C | C | B | B | B | B |
| | 4 | C | C | C | C | C | C | C |
| | 5 | C | C | C | B | B | B | B |
| | 6 | C | C | C | A | A | A | A |

Aspects of the present disclosure are, for example, as follows.

1. An image forming method includes applying an ink A containing carbon black, a first organic solvent, and water and an ink B containing a pigment including no carbon black, a second organic solvent, and water to a recording medium to form an image thereon and applying infrared rays to the image to dry the image. The average vapor pressure ratio {P(B)/P(A)} of the average vapor pressure P(B) of water and the second organic solvent contained in the ink B at 100 degrees C. to the average vapor pressure P(A) of water and the first organic solvent contained in the ink A at 100 degrees C. is from 1.00 to 2.00. A content ratio {W(A)/W(B)} of a content W(A) of the carbon black applied to the recording medium per unit area to a content W(B) of the pigment applied to the recording medium per unit area is from 1.00 to 100.0.

2. The image forming method according to 1 mentioned above, wherein the pigment other than the carbon black is at least one member selected from the group consisting of cyan pigment, magenta pigment, and yellow pigment.

3. The image forming method according to 1 or 2 mentioned above, wherein the total content of the carbon black and the pigment in an area of 210 mm×297 mm of the recording medium on which the image is formed is from 1.0 to 1,000.0 mg.

4. The image forming method according to any one of 1 to 3, wherein the mass ratio X(A) of the carbon black contained in the ink A to the total content of water and the organic solvent contained in the ink A and the mass ratio X(B) of the pigment other than carbon black contained in the ink B to the total content of water and the organic solvent contained in the ink B are from 0.55 to 25.5 percent by mass.

5. The image forming method according to 4 mentioned above, wherein the ratio of the mass ratio of X(A) to the mass ratio X(B) is from 1.0 to 10.0.

6. The image forming method according to 5 mentioned above, wherein the ratio {X(A)/X(B)} is from 1.20 to 10.0.

7. The image forming method according to any one of 1 to 6 mentioned above, wherein the average vapor pressure P(A) and the average vapor pressure P(B) are from 300 to 600 mmHg.

8. The image forming method according to any one of 1 to 7 mentioned above, wherein the image is dried in 1.0 to 30.0 seconds in the step of applying infrared rays.

9. The image forming method according to any one of 1 to 8 mentioned above, wherein the image is dried at temperatures of from 200 to 1,300 degrees C. in the step of applying infrared rays.

10. The image forming method according to any one of 1 to 9, wherein heated wind of 80 degrees C. or higher is applied to the image in the step of applying infrared rays.

11. The image forming method according to any one of 1 to 10, wherein the content W(A) (μg/cm²) of carbon black applied to the recording medium per unit of area is from 7.5 to 14.85 μg/cm².

12. The image forming method according to any one of 1 to 11, wherein the content W(B) (μg/cm²) of the pigment applied to the recording medium per unit of area is from 0.15 to 7.5 μg/cm².

13. An image forming apparatus includes an image forming device to apply an ink A including carbon black, an organic solvent (first organic solvent), and water and an ink B comprising a pigment other than carbon black (i.e., including no carbon black), an organic solvent (second organic solvent), and water to a recording medium to form an image thereon; and a drying device to apply infrared rays to the image to dry the image. The average vapor pressure ratio {P(B)/P(A)} of the average vapor pressure P(B) of water and the second organic solvent contained in the ink B at 100 degrees C. to the average vapor pressure P(A) of water and the first organic solvent contained in the ink A at 100 degrees C. is from 1.00 to 2.00. Also, the content ratio {W(A)/W(B)} of the content W(A) of carbon black applied to the recording medium per unit area to a content W(B) of the pigment applied to the recording medium per unit area is from 1.00 to 100.0. The image forming method can be conducted by the image forming apparatus.

14. The image forming apparatus according to 13 mentioned above, wherein the pigment is at least one member selected from the group consisting of cyan pigment, magenta pigment, and yellow pigment.

15. The image forming apparatus according to 13 or 14 mentioned above, wherein the total content of the carbon black and the pigment in an area of 210 mm×297 mm of the recording medium on which the image is formed is from 1.0 to 1,000.0 mg.

16. The image forming apparatus according to any one of 13 to 15 mentioned above, wherein the mass ratio X(A) of the content of carbon black contained in the ink A to the total content of water and the organic solvent contained in the ink A and the mass ratio X(B) of the pigment contained in the ink B to the total content of water and the organic solvent contained in the ink B are from 0.55 to 25.5 percent by mass.

17. The image forming apparatus according to 16 mentioned above, wherein the ratio of the mass ratio X(A) to the mass ratio X(B) is from 1.0 to 10.0.

18. The image forming apparatus according to 17 mentioned above, wherein the ratio of the mass ratio X(A) to the mass ratio X(B) is from 1.20 to 10.0.

19. The image forming apparatus according to any one of 13 to 18 mentioned above, wherein each of the average vapor pressure P(A) and the average vapor pressure P(B) is from 300 to 600 mmHg.

20. The image forming apparatus according to any one of 13 to 19 mentioned above, wherein the image is dried in 1.0 to 30.0 seconds in the step of the application of infrared rays.

According to the present disclosure, an image forming method is provided which produces images with good drying property and free of image deficiency such as visible blister or kogation on plain paper and commercial printing paper

Having now fully described embodiments of the present invention, it will be apparent to one of ordinary skill in the art that many changes and modifications can be made thereto without departing from the spirit and scope of embodiments of the invention as set forth herein.

What is claimed is:

1. An image forming method comprising:
applying an ink A comprising carbon black, a first organic solvent, and water and an ink B comprising a pigment including no carbon black, a second organic solvent, and water to a recording medium to form an image thereon; and
applying infrared rays to the image to dry the image,
wherein an average vapor pressure ratio {P(B)/P(A)} of an average vapor pressure P(B) of water and the second organic solvent contained in the ink B at 100 degrees C. to an average vapor pressure P(A) of water and the first organic solvent contained in the ink A at 100 degrees C. is from 1.00 to 2.00,
wherein a content ratio {W(A)/W(B)} of a content W(A) of the carbon black applied to the recording medium per unit area to a content W(B) of the pigment applied to the recording medium per unit area is from 1.00 to 100.0.

2. The image forming method according to claim 1, wherein the pigment is at least one member selected from the group consisting of a cyan pigment, a magenta pigment, and a yellow pigment.

3. The image forming method according to claim 1, wherein a total content of carbon black and the pigment in an area of 210 mm×297 mm of the recording medium on which the image is formed is from 1.0 to 1,000.0 mg.

4. The image forming method according to claim 1, wherein each of a mass ratio X(A) of a content of carbon black contained in the ink A to a total content of water and the first organic solvent contained in the ink A and the a mass ratio X(B) of a content of the pigment contained in the ink B to a total content of water and the second organic solvent contained in the ink B is from 0.55 to 25.5 percent by mass.

5. The image forming method according to claim 4, wherein a ratio of the mass ratio X(A) to the mass ratio X(B) is from 1.0 to 10.0.

6. The image forming method according to claim 1, wherein each of the average vapor pressure P(A) and the average vapor pressure P(B) is from 300 to 600 mmHg.

7. The image forming method according to claim 1, wherein the image is dried in 1.0 to 30.0 seconds in the step of applying infrared rays.

8. The image forming method according to claim 1, wherein the image is dried at temperatures of from 200 to 1,300 degrees C. in the step of applying infrared rays.

9. The image forming method according to claim 1, wherein the image is further dried by heated wind of 80 degrees C. or higher in the step of applying infrared rays.

10. An image forming apparatus comprising:
an image forming device configured to apply an ink A comprising carbon black, a first organic solvent, and water and an ink B comprising a pigment including no carbon black, a second organic solvent, and water to a recording medium to form an image thereon; and a drying device to apply infrared rays to the image to dry the image,
wherein an average vapor pressure ratio {P(B)/P(A)} of an average vapor pressure P(B) of water and the second organic solvent contained in the ink B at 100 degrees C. to an average vapor pressure P(A) of water and the first organic solvent contained in the ink A at 100 degrees C. is from 1.00 to 2.00,
wherein a content ratio ({W(A)/W(B)} of a content W(A) of carbon black applied to the recording medium per unit area to a content W(B) of the pigment applied to the recording medium per unit area is from 1.00 to 100.0.
